(19) United States
(12) Patent Application Publication
(10) Pub. No.: US 2012/0224488 A1
(43) Pub. Date: Sep. 6, 2012

(54) METHOD OF CONNECTIVITY MONITORING BY SUBSCRIBER LINE TERMINATING APPARATUS

(76) Inventors: Masao NIIBE, Fujisawa (JP); Akihiko Tsuchiya, Fujisawa (JP); Takayuki Kanno, Yokohama (JP); Yoshihiro Ashi, Yokohama (JP)

(21) Appl. No.: 13/370,001

(22) Filed: Feb. 9, 2012

(30) Foreign Application Priority Data
Mar. 3, 2011 (JP) 2011-045850

(51) Int. Cl. H04L 12/26

(52) U.S. Cl. 370/241.1

(57) ABSTRACT

A method carrying out connectivity monitoring of an entire network by: transmitting a CCM frame in which the transmission source is set to a multicast MAC address, from a higher level side (center side) terminating device to a plurality of lower level side (base point side) terminating devices; transmitting a CCM frame in which a unicast MAC address is set, from the lower level side terminating devices to the higher level side terminating device; transmitting a CCM frame in which a multicast MAC address is set, from a controller to the higher level side terminating device or the lower level side terminating devices; and transmitting a CCM frame in which a unicast MAC address is set, from the higher level side terminating device or the lower level side terminating devices to the controller.

### INCORPORATION BY REFERENCE

The present application claims priority from Japanese application 2011-045850 filed on Mar. 3, 2011, the content of which is hereby incorporated by reference into this application.

### BACKGROUND OF THE INVENTION

The present invention pertains to a network configuration for monitoring the connectivity of communication lines extending over packet communication networks with different administrators as well as an apparatus used for the monitoring.

In recent years, Ethernet (R) has not only been limited to the LAN (Local Area Network) domain but has also gained rapid acceptance in carrier networks such as Wide Area Ethernet service. However, compared to other protocols such as ATM (Asynchronous Transfer Mode) that have come to be used in conventional transmission networks, there had come to be regarded as an issue requiring attention with respect to packet communication protocols, starting with Ethernet, the administration of the quality thereof, since no OAM (Operation Administration and Maintenance) function was defined.

In recent years, due to the fact that there has been carried out a debate about these in the standardization bodies ITU-T (International Telecommunication Union-Telecommunication standardization sector) and IEEE (Institute of Electrical and Electronics Engineers), there has been introduced an OAM function for Ethernet that is defined in ITU-T Recommendation Y.1731 (Non-patent Reference 1) and the document IEEE 802.1ag (Non-patent Reference 2). In addition, standardization has also been completed for ITU-T Recommendation G8031/Y.1342 (Non-patent Reference 3), a path switching (protection) method using an OAM function.

Hereby, since maintenance administration pertaining to communication services with an Ethernet network becomes possible, the practical implementation of an OAM function in packet communication networks including Ethernet has started. As for Ethernet, normally, it is often applied to a LAN possessed by a private individual or a corporate user, but by providing a quality administration function, attention is paid to the operation thereof, even in infrastructure services provided by a carrier. Even regarding a residential device installed inside a user residence, the introduction of Ethernet OAM (hereinafter called “Ethernet OAM”) is being investigated.

Conventionally, carriers have come to provide a service constructing, based on a leased line or L2-VPN (Layer 2 Virtual Private Network) service, a relay network between user sites. In this case, the term “user” often mainly refers to a corporate user such as an enterprise. This is because inter-site mutual communication has come to be taken as necessary, such as in the case where a user takes as an object disaster avoidance or load distribution of servers or the like and possesses a plurality of sites in respectively differing locations or also, in the case of having a plurality of sites in response to an enterprise scale with a head office and branch offices.

With a service constructing a relay network for connecting, among themselves, these user sites present in geographically separated locations, a bandwidth guarantee corresponding to the contract of the user is carried out inside a relay network provided by the carrier. For the communication between mutually separated sites, it took a form extending over a plurality of networks having different administrators, such as access network providers providing infrastructure close to the users and a carrier providing a core network connecting the same access networks among themselves, so an end-to-end bandwidth guarantee between devices used by users was difficult. As a result, there is mainly utilized encrypted communication using a higher-level protocol such as L2-VPN service using MPLS (Multi Protocol Label Switching) or the like.

In addition to bandwidth guarantee services using such a higher-level protocol, accompanying the previously mentioned OAM standardization, communication administration with a lower-level protocol such as Layer 2 (hereinafter called “L2”) has become possible. Also, access network providers are in the process of switching over from high-cost leased line devices to packet communication devices. If, in this way, user networks, access networks, and core networks are connected by means of packet communication devices, the establishment of a connection for consistently administering access networks and core networks becomes simple, something that was difficult in the past.

Specifically, a method in which the carrier providing the core network installs remote devices inside user sites and administers the entire communication between user sites stretching over access network providers is being gradually introduced. In this case, the access network providers end up in a position of providing communication lines to the carrier possessing the core network. Conventionally, a carrier close to the lower levels of the transmission network (core network) was in a position of providing resources to the access network provider, but together with the fact that the functions of packet communication networks are being expanded, the business model has come to be transformed.

### SUMMARY OF THE INVENTION

This far, in the case where a communications operator such as a carrier provided a network between large-scale users, the communications operator conducted suitable cost charging depending on the scale of the network and constructed the network. In recent years, due to the fact that regional networks such as L2-VPN networks that are constructed by regional operators such as access network operators are also put to practical use as relay networks, there is a movement to strive for the aforementioned cost reductions. At this point, the service-providing communications operator also, apart from the network he administers himself, makes regional networks administered by other operators the object of maintenance and monitoring for the subscriber to carry out administration of the entire network.

Since, at the time a malfunction occurs, the operator carries out a designation of the failed segment and a designation of the communication line accommodating the service under influence, there is a need to conduct ascertainment and a mutual understanding test of the alarm state for each of the devices constituting the network. However, in the case of utilizing large-scale networks and a plurality of regional networks as relay networks, there are cases requiring time for the ascertainment of the situation.

As a result, in the aforementioned maintenance and monitoring, in order for the communications operator providing the service to nimbly carry out ascertainment of the malfunction situation, monitoring of the connectivity between each of the terminating devices for which a service communication line is accommodated from the user device becomes effective. In this case, the application of the CCM (Continuity Check Message) frame which is utilized in connectivity monitoring in Ethernet OAM emerges as a candidate, but it becomes necessary to take into accounted the two points mentioned below. The first point is that, in the simple monitoring of the connectivity between each of the terminating devices, there is a risk that, depending on the place of failure occurrence, failure detection is reported unnecessarily from a plurality of terminating devices. The second point is that, in order to decrease the load on the original user traffic as much as possible, there is a need to carry out transmission and reception of CCM frames to a minimum between each of the terminating devices.

Inside the base point of the user, by setting dependency relationships with devices terminating OAM signals such as CCM frames conducting connectivity monitoring between the terminating device on the higher-level side (master) and a plurality of terminating devices on the lower-level side (slaves), a clarification of the failure detection segment is implemented.

Also, a CCM frame in which the destination multicast MAC (Media Access Control) address is set is transmitted from the terminating device on the higher-level side to the plurality of terminating devices on the lower-level side, and a CCM frame in which the destination is set to a unicast MAC address is transmitted from the terminating devices on the lower-level side to the (center-side) terminating device on the higher-level side.

A CCM frame (hereinafter also named an “Eth-CC signal”) in which the destination is set to a multicast MAC address is transmitted from a control device controlling each of the terminating devices (hereinafter named either a “control device” or a “controller”) to the terminating device on the higher-level side or the terminating devices on the lower-level side and a CCM frame in which the destination is set to a unicast MAC address is transmitted from the terminating device on the higher-level side or the terminating devices on the lower-level side to the controller.

According to the present invention, the segment conducting connectivity monitoring becomes the interval between the control device and each of the terminating devices and the space between the terminating device on the higher-level side and the terminating devices on the lower-level side, so a clarification of the monitoring segment becomes possible. In this way, it becomes possible for the communications operator to immediately grasp and respond to the scope of service influence with respect to a connectivity anomaly report at the time of a failure occurrence. Also, regarding the transmission of CCM frames from the control device to each of the terminating devices and transmission of CCM frames from the terminating device on the higher-level side to terminating devices on the lower-level side, the transmission source, by utilizing a multicast MAC address for the destination, is able to transmit the CCM frames collectively to a plurality of transmission recipients. In this way, the communications operator can, in the network design, set the consumed bandwidth to the minimum necessary and reduce the user traffic load by transmission and reception of CCM frames used in connectivity monitoring.

Other objects, features and advantages of the invention will become apparent from the following description of the embodiments of the invention taken in conjunction with the accompanying drawings.

### BRIEF DESCRIPTION OF THE DRAWINGS

FIG. 1 is a network configuration example showing a L2-VPN network based on an embodiment of the present invention.

FIG. 2 is a frame configuration example of a user frame transmitted and received between user base points via a terminating device.

FIG. 3 is a frame configuration example of an Ethernet OAM frame communicated between terminating devices or between terminating devices and a controller.

FIG. 4 is a frame configuration example showing an Eth-CC signal utilized in connectivity monitoring.

FIG. 5 is a block diagram showing an embodiment of a controller controlling terminating devices.

FIG. 6 is a block diagram showing an embodiment of a center-side terminating device.

FIG. 7 is a block diagram showing an embodiment of a terminating device on the base point side.

FIG. 8 is an example of a sequence in which a controller controlling terminating devices reports registration information to a terminating device on the center side.

FIG. 9 is an example of a sequence in which a controller controlling terminating devices reports registration information to a terminating device on the base point side.

FIG. 10 is an example of a sequence in which a terminating device on the center side and a terminating device on the base point side mutually conduct MAC address learning.

FIGS. 11A and 11B are examples of tables showing registration information administered by a controller controlling terminating devices.

FIGS. 12A and 12B are examples of tables showing connection information administered by a terminating device on the center side.

FIGS. 13A and 13B are examples of tables showing connection information administered by a terminating device on the base point side.

FIG. 14 is an example of the processing flow of a frame transferred by a terminating device from an L2-VPN network.

FIG. 15 is an example of a processing flow in which the controller controlling the terminating devices judges the connection state.

FIG. 16 is an example of a processing flow in which the terminating devices judge the connection state.

### DETAILED DESCRIPTION OF THE INVENTION

Hereinafter, using the drawings, the configuration and operation of a network according to the present invention will be described taking as an example the configuration and the operation of Ethernet OAM specified in ITU-T Recommendation Y.1731 (Non-patent Reference 1).

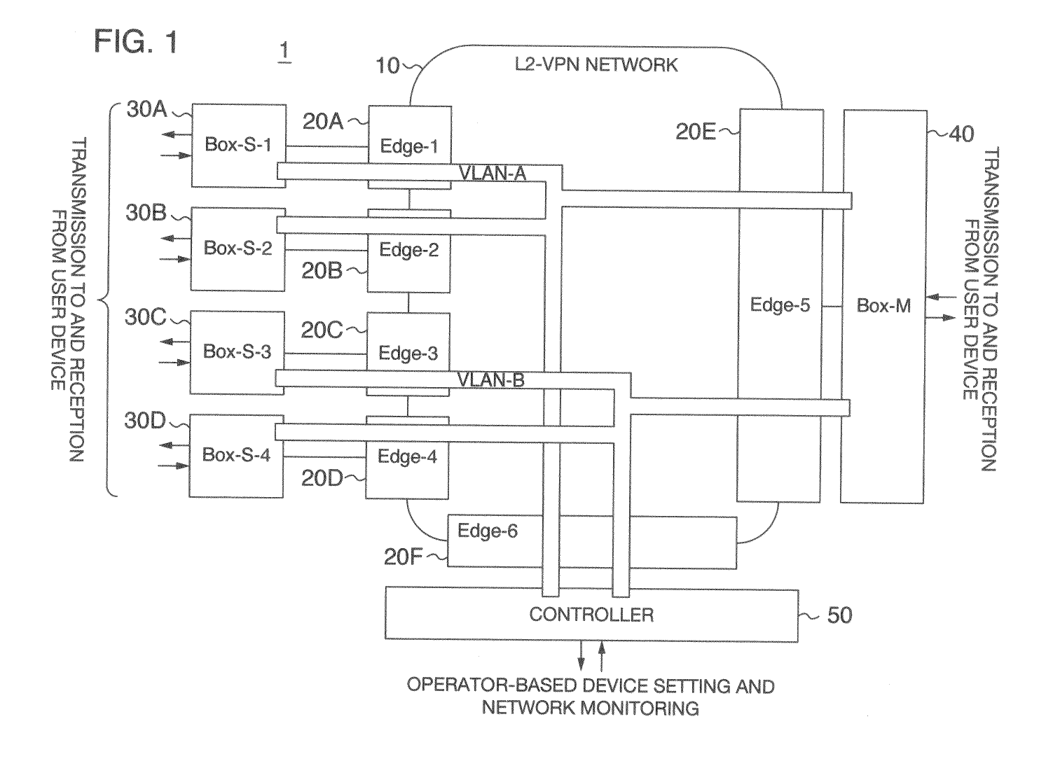

FIG. 1 is a network block diagram for describing an example of an embodiment of the present invention.

In a network 1, there is shown a situation in which e.g. the terminals of users subscribing to a service (subscribers) making a connection between base points (hereinafter called “user terminals”) are arranged in various places and Box-S 30 and Box-M 40, terminating devices which are likewise arranged in various places, make these user devices connect with a L2-VPN (Layer 2 Virtual Private Network) network 10. Here, Box-M 40 is e.g. a terminating device arranged on the center side such as a large urban district where a user draws together various base points and Box-S 30 is e.g. a terminating device arranged by a user on the base point side such as a provincial district. This terminating device may be a separate device or a device such as an edge home gateway installed in a user residence or a subscriber station, or it may be incorporated in a relay device such as a router or a switch.

The terminating devices installed in various places are connected with an edge device 20 such as an L2 switch arranged on the edge of a relaying L2-VPN network 10 and carry out communication in a network set to a VLAN (Virtual Local Area Network), as the need arises.

Here, edge device 20 or Box-M 40 and Box-S 30 are e.g. devices possessed by a carrier being a communications operator and, there being assumed a use mode in which Box-M 40 and Box-S 30 are leased by the carrier to the user and installed inside the residence or the office of the user. Also, the network between the terminating devices, such as Box-M 40 and Box-S 30, and edge device 20 may also be constituted by networks administered by regional operators other than carriers, such as access network providers. In addition, the network situated between the edge devices may be regarded as a network administered by the carrier. Further, regarding which part of the network of FIG. 1 is administered by whom, there are different variations apart from the aforementioned example and the present embodiment can be implemented no matter how the administration of network 1 is subdivided.

In FIG. 1, there are arranged four Box-S terminals, Box-S-1 30A, Box-S-2 30B, Box-S-3 30C, and Box-S-4 30D, as terminating terminals on the base point side such as a provincial district. Also, as a terminating terminal on the center side, there is arranged one Box-M 40. Additionally, a controller 50 remotely controlling each of the terminating devices is also connected, via L2-VPN network 10 and an L2 switch.

Also, controller 50, Box-M 40, and Box-S 30 constitute a network in a VLAN via L2-VPN network 10. In concrete terms, controller 50, Box-M 40, Box-S-1 30A, and Box-S-2 30B construct a network for which the VLAN ID has been set to VLAN A and controller 50, Box-M 40, Box-S-3 30C, and Box-S-4 30D construct a network for which the VLAN ID has been set to VLAN B.

Since controller 50 controls Box-M 40 or Box-S 30 between controller 50 and Box-M 40 or Box-S 30, it is a communication path constructed for transmitting and receiving mainly Ethernet OAM signals. The interval between each of the terminating devices is a communication path for transferring user frames used in the communication between the base point and the center by the user and Ethernet OAM signals, to be subsequently described, that carry out connectivity monitoring and the like between the terminating devices.

Also, between each of the terminating devices, there is chosen a mode in which a plurality of Box-S 30 on the base point side are subordinate, under the command of one Box-M 40 on the center side. If an example is to be cited, in a certain enterprise network, when it comes to user devices connected with the front of Box-S 30 on the base point side, there are terminals installed in each of the branch offices, and when it comes to user devices connected with the front of Box-M 40 on the center side, there are data centers installed which bring together each of the branch offices, the network being one in which the devices mutually transmit and receive. The aforementioned example is only an example, the present embodiment not necessarily being one that is limited to the aforementioned example.

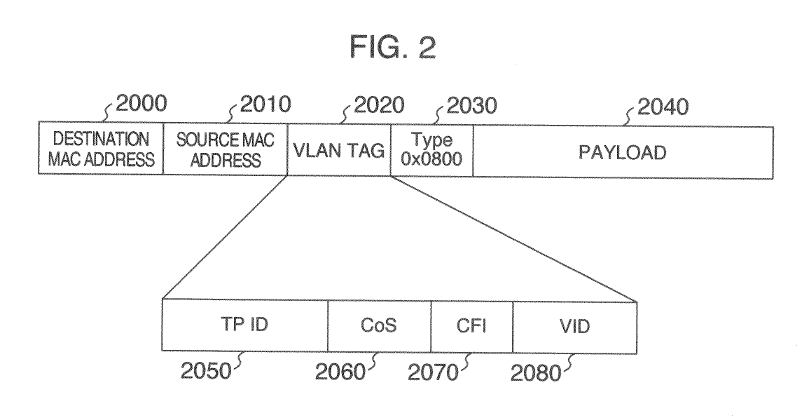

FIG. 2 is a frame configuration example of a user frame that is transferred from a user device, transmitted and received to and from Box-M 40 and Box-S 30, and for conveying data.

The user frame is e.g. composed of a destination MAC address 2000, a source MAC address 2010, a VLAN tag 2020, a type 2030, and a payload 2040. VLAN tag 2020 is standardized in IEEE 802.1 Q. VLAN tag 2020 is composed of a TP ID 2050 indicating that it is a VLAN tab, a Cos 2060 indicating the priority of the frame, a token ring encapsulation flag CFI 2070, and a VID 2080 used in the identification of the VLAN. The route inside the L2-VPN network is determined by VID 2080. Type 2030 is a number identifying a higher-level protocol. E.g., it is “0×0800” if what is concerned is IPv4. Payload 2040 indicates the main part of the user frame data.

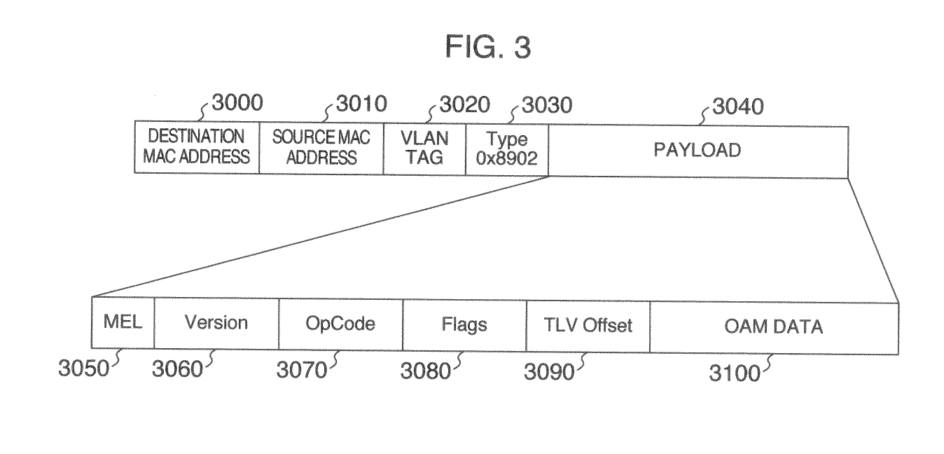

FIG. 3 is a frame configuration example of an Ethernet OAM signal frame being transmitted and received by Box-M 40, Box-S 30, or controller 50.

The Ethernet OAM signal is e.g. composed of a destination MAC address 3000, a source MAC address 3010, a VLAN tag 3020, a Type 3030, and a payload 3040. Type 3030 of the Ethernet OAM signal is “0x8902”. Payload 3040 is Ethernet OAM data and has its format specified by IEEE 802.1ag and ITU-T Recommendation Y.1731. Payload 3040 is composed of a MEL item 3050, a Version item 3060, an OpCode item 3070, a Flags item 3080, a TLV Offset item 3090, and an OAM data item 3100. MEL item 3050 indicates the administration level (MEG level) of the Ethernet OAM signal. Version item 3060 is an identifier for identifying the version of the Ethernet OAM signal. OpCode item 3070 is an identifier for identifying the functions of the Ethernet OAM signal. E.g., it is “0x01” if the Ethernet OAM signal is an Eth-CC signal which is a CCM frame utilized in connectivity monitoring by the Ethernet OAM signal. Flags item 3080 indicates, in the Eth-CC signal, the communication alarm detection and transmission period in the OAM termination node. TLV Offset item 3090 indicates the number of bytes of the fixed field up to the TLV (Type Length Value). OAM data item 3100 indicates the data specified by OpCode item 3070.

On the occasion of transmitting and receiving the Ethernet OAM signal, controller 50, Box-M 40, or Box-S 30, changes the MEG level, depending on the transmission destination, by modifying MEL item 3050 inside the Ethernet OAM signal. This is to say that, with respect to the MEG level of the Ethernet OAM signal used between controller 50 and Box-M 40 or Box-S 30, a higher value is set for the MEG level of the Ethernet OAM signal used between Box-M 40 and Box-S 30. E.g., in the case of setting the MEG level of the Ethernet OAM signal between controller 50 and Box-M 40 or Box-S 30 to “3”, the MEG level of the Ethernet OAM signal between Box-M 40 and Box-S 30 is set to “4”. This is because the communication between Box-M 40 and Box-S 30, which communicates among the termination points of the communication lines with which the user devices transmit and receive, is different from the communication between controller 50 and Box-M 40 or Box-S 30, which communicates in a control segment for controlling the terminating devices.

Further, in case the MEG level is taken to be the object of maintenance and administration between the user base points, it is normal that it is set to a higher numerical value. And then, it is a normal convention that the MEG level is set to a lower numerical value as the space between networks of access network providers, the core network of the carrier, and the network being the object of maintenance and administration become narrower.

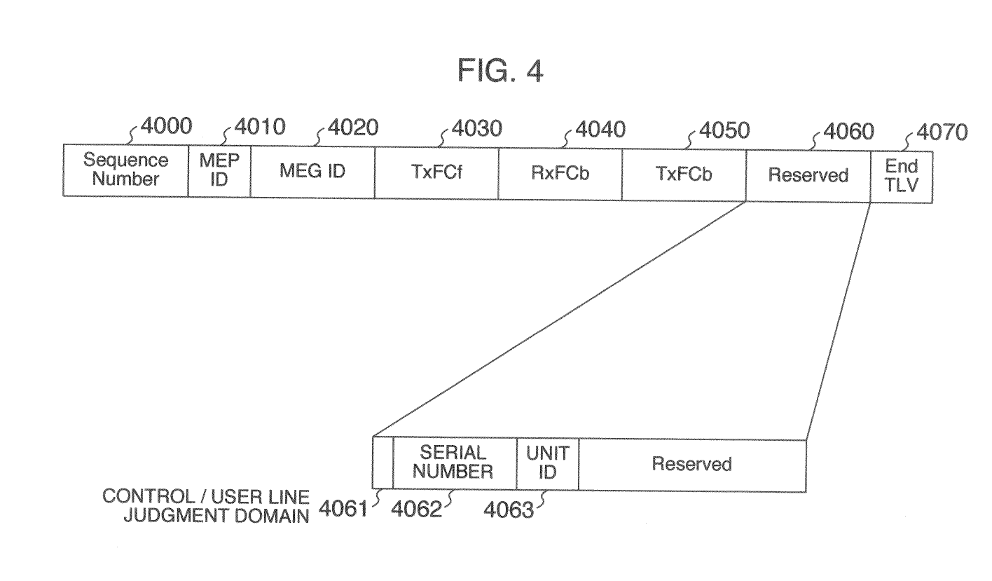

FIG. 4 is a frame configuration example showing OAM data item 3100 in the case where the Ethernet OAM signal is an Eth-CC signal used in connectivity monitoring.

In the case of an Eth-CC signal, Ethernet OAM-type OAM data item 3100 is e.g. composed of a Sequence Number item 4000, a MEP ID item 4010, a MEG ID item 4020, a TxFCf item 4030, an RxFCb item 4040, a TxFCb item 4050, a Reserved item 4060, and an End TLV item 4070. Each item is specified in ITU-T Recommendation Y 1731. Sequence Number item 4000 indicates the sequence number of the present signal. MEP ID item 4010 indicates the MEP ID. MEG ID item 4020 indicates the MEG ID with which the present signal is affiliated. TxFCf item 4030 expresses the total number of user frames transmitted to the opposite MEP until the transmission of the present Eth-CC signal. RxFCb item 4040 expresses the number of user frames received from the opposite MEP between the reception of the previous Eth-CC signal and the present Eth-CC signal. TxFCb item 4050 expresses the number of user frames transmitted to the opposite MEP between the sending out of the previous Eth-CC signal and the sending out of the present Eth-CC signal. Reserved item 4060 indicates the unused domain. End TLV 4070 indicates the termination of OAM data item 3100.

In the present embodiment, there is carried out transmission and reception of information needed for effectively transmitting and receiving the Eth-CC signals with controller 50, Box-M 40, and Box-S 30, utilizing the domain of Reserved item 4060. Because of this, in the present embodiment, a control/user line judgment domain 4061, a serial number 4062, and a unit ID 4063 are provided in the domain of Reserved item 4060.

Control/user line judgment domain 4061, in the case where a terminating device such as Box-M 40 or Box-S 30 receives the first Eth-CC signal, stores information for judging whether the same Eth-CC signal is one from controller 50 or whether it is one from another terminating device. Specifically, 48 bits are present in Reserved item 4060 and e.g. the leading bit is defined to be control/user line judgment domain 4061. E.g., in the case where control/user line judgment domain 4061 is “1”, the concerned Eth-CC signal is taken to be an Eth-CC signal from controller 50, whereas in the case where control/user line judgment domain 4061 is “0”, the concerned Eth-CC signal is taken to be an Eth-CC signal from a terminating device (Box-M 40 or Box-S 30).

In serial number item 4062, there is stored a number with which the header is uniquely set at the time of shipping of each terminating device, e.g. a serial number being the manufacturer's serial number of Box-M 40 or Box-S 30. However, regarding this serial number, it is an example, it also being acceptable with identification information with which controller 50 is capable of distinguishing an arbitrary terminating device from some other terminating device and uniquely identifying the same. This serial number 4062 is stored e.g. from the second leading bit to the fifteenth bit (14 bits) in the domain of Reserved item 4060. With 14 bits, it becomes possible to uniquely set serial numbers 1 to 16383, respectively.

As will be subsequently described, in the present embodiment, when controller 50, after having obtained registration information from the operator, has received the first Eth-CC signal from a terminating device, controller 50 knows the serial numbers of the same terminating devices but is in a state in which it does not know the MAC addresses. Because of this, controller 50 judges, by checking this serial number 4062, from which terminating device the Eth-CC signal was transmitted.

In unit ID 4063, an ID is set uniquely for each terminating device, inside the network constructed by the communications operator. E.g., in network 1, in order to uniquely identify each terminating device for each VLAN, it is an ID which is set uniquely for each terminating device. However, regarding this ID, it is an example and in the network with which the terminating device itself is associated (e.g. a VLAN or the like), it is acceptable if what is concerned is identity information with which it is possible to uniquely identify the other terminating devices. The aforementioned ID is stored, e.g. in the domain of Reserved item 4060, in the 16^{th} to 23^{rd} leading bits (eight bits). With eight bits, it is possible to respectively set uniquely unit IDs 1 to 255.

As will be subsequently described, in the present embodiment, when Box-M 40 or Box-S 30 has received the first Eth-CC signal from another terminating device after a normal operation transition, the unit ID of another terminating device having received the Eth-CC signal is known, but the state is one in which the MAC address is not known. Because of this, the terminating device having first received these Eth-CC signals judges, by checking this unit ID 4063, from which terminating device the Eth-CC signal was transmitted.

In the present embodiment, as described above, the domain of Reserved item 4060 is shaped so that the necessary information is transmitted and received, but this is not anything that is related to the present technique and has only been raised as an example, it also being acceptable to make a definition among devices to use a domain apart from that of Reserved item 4060 inside the Eth-CC signal and store these pieces of information. E.g., regarding serial numbers and unit IDs, it does not matter if an appropriate domain capable of storing IDs such as MEG ID 4020 is used.

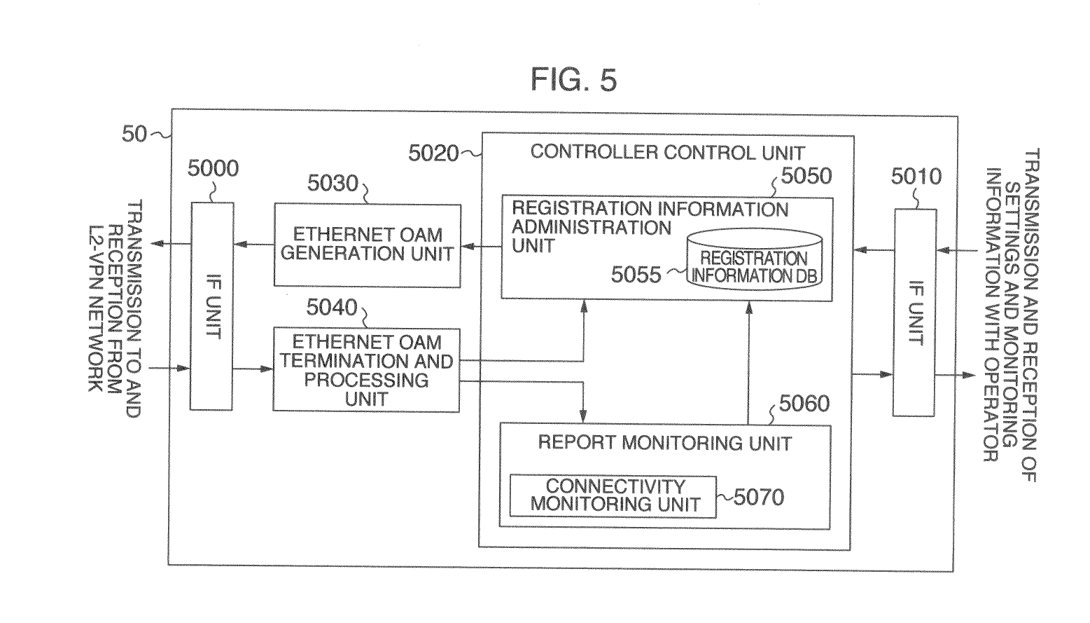

FIG. 5 is an example of a block diagram of controller 50.

Controller 50 is e.g. composed of IF units 5000 and 5010, a controller control unit 5020, an Ethernet OAM generation unit 5030, and an Ethernet OAM termination and processing unit 5040. Controller control unit 5020 is e.g. composed of a registration information administration unit 5050 and a report monitoring unit 5060. Registration information administration unit 5050 has e.g. a registration information DB (Database) 5055 built in. In report monitoring unit 5060, there is e.g. built in a connectivity monitoring unit 5070.

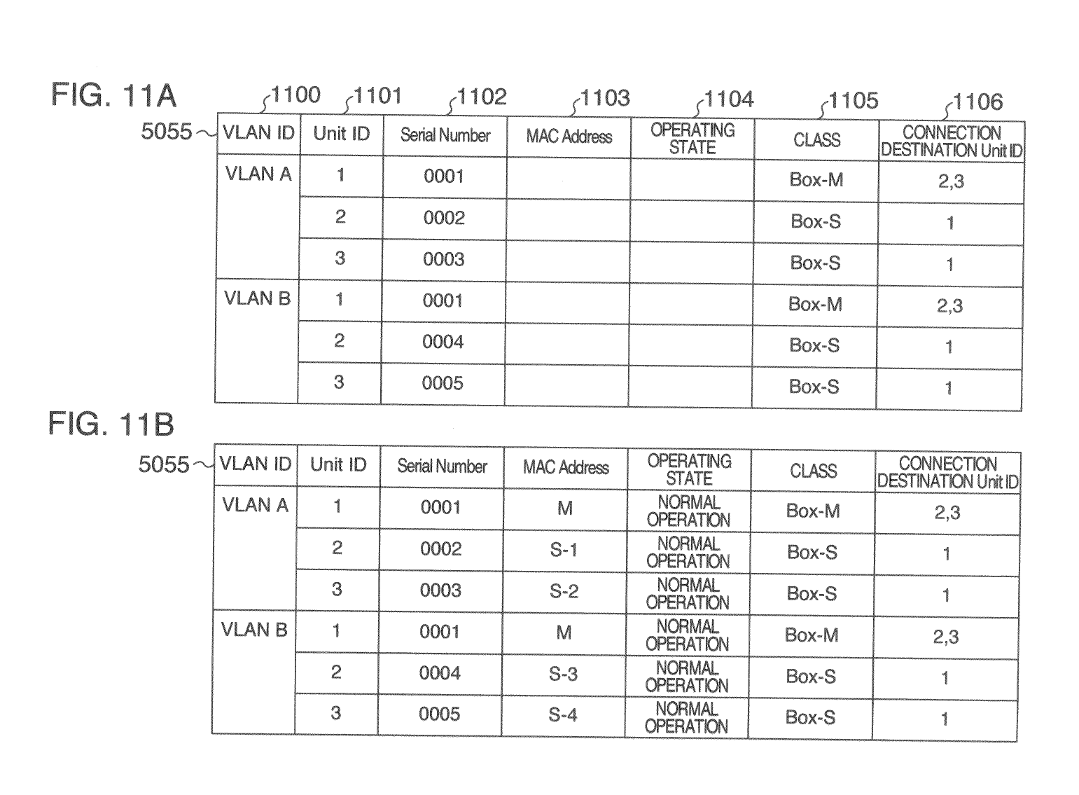

Controller 50 carries out transmission and reception of information with the operator in controller control unit 5020 via IF unit 5010 which is an interface with the outside. Registration information DB 5055 inside registration information administration unit 5050 is a database in which the registration information of each of the terminating devices Box-M 40 and Box-S 30 reported from the operator is stored. This registration information is not only necessary for making Box-M 40 and Box-S 30 switch over to normal operation but is also utilized in the connectivity monitoring of the concerned devices. Ethernet OAM generation unit 5030 has a function of generating and transmitting, in accordance with the instructions of registration information administration unit 5050, Ethernet OAM signals for control aimed at Box-M 40 and Box-S 30. The Ethernet OAM signal generated in Ethernet OAM generation unit 5030 is transmitted to L2-VPN network 10 via IF unit 5000. Regarding registration information DB 5055, a description thereof will be subsequently given in FIG. 11.

Ethernet OAM termination and processing unit 5040 has a function of judging whether or not a signal transmitted from L2-VPN network 10 is an Ethernet OAM signal bound for the unit itself. Ethernet OAM termination and processing unit 5040, if judging that the concerned signal is an Ethernet OAM signal bound for the unit itself, transfers the concerned signal to report monitoring unit 5060 or registration information administration unit 5050. Report monitoring unit 5060 analyzes signals transferred from Ethernet OAM termination and processing unit 5040 and, if what is concerned is a report signal, notifies the states of Box-M 40 and Box-S 30 to the operator, as the need arises. Also, connectivity monitoring unit 5070 monitors an Eth-CC signal from Box-M 40 or Box-S 30 and, in case no Eth-CC signal is received for a fixed time interval, judges that an anomaly has occurred in the connectivity with the concerned device and carries out a report to the operator.

Controller 50, in the case of transmitting an Eth-CC signal for carrying out monitoring of connectivity with Box-M 40 or Box-S 30 to the same terminating devices, sets the destination MAC address to a multicast MAC address and transmits the same, to each of the terminating devices, for each VLAN ID registered in the controller itself. As for controller 50, by transmitting an Eth-CC signal in which destination MAC address 3000 is set to a multicast MAC address, it becomes possible to transmit together a plurality of terminating devices.

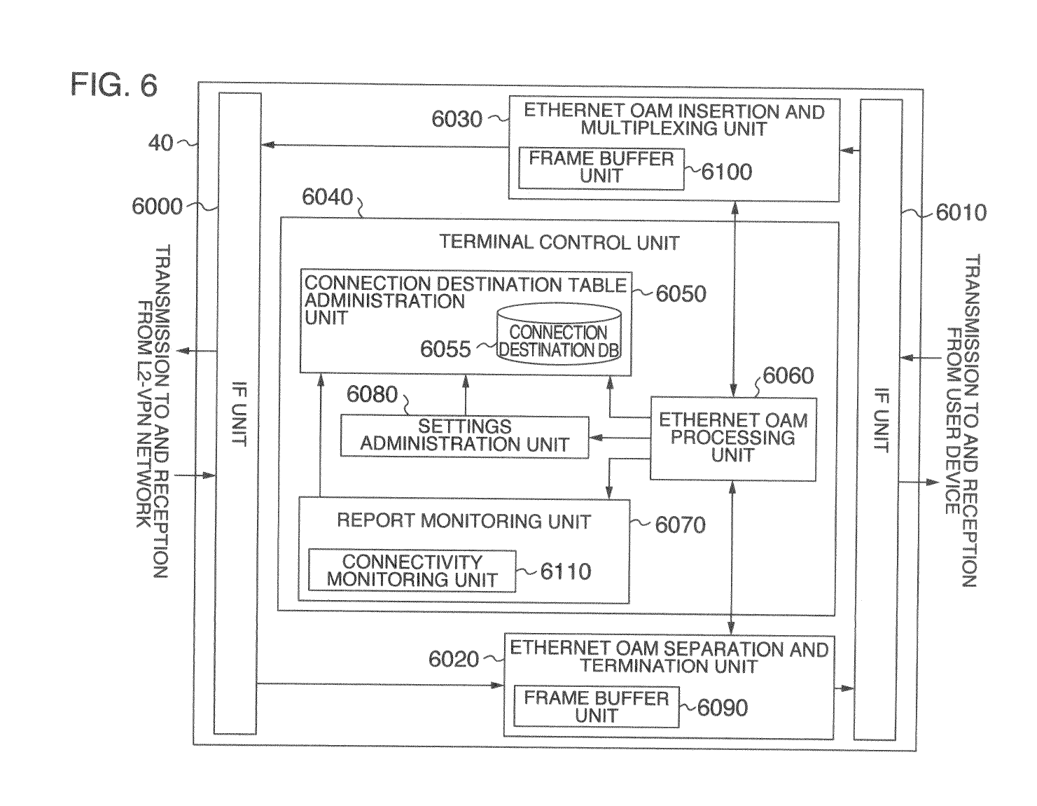

FIG. 6 is an example of a block diagram of a terminating device Box-M 40 on the center side.

Box-M 40 is e.g. composed of IF units 6000 and 6010, an Ethernet OAM separation and termination unit 6020, an Ethernet OAM inserting and multiplexing unit 6030, and a terminal control unit 6040. Terminal control unit 6040 is e.g. composed of a connection destination administration table 6050, an Ethernet OAM processing unit 6060, a report monitoring unit 6070, and a settings administration unit 6080. In report monitoring unit 6070, there is e.g. built in a connectivity monitoring unit 6110. In Ethernet OAM separation and termination unit 6020 and Ethernet OAM insertion and multiplexing unit 6030, there are e.g. built in frame buffer units 6090 and 6100. Connection destination table administration unit 6050 e.g. has a connection destination DB 6055 built in.

Box-M 40 receives a signal from L2-VPN network 10 with frame buffer unit 6090 inside Ethernet OAM separation and termination unit 6020 via an IF unit 6000 which is an interface with the outside. Ethernet OAM separation and termination unit 6020 has a function of judging whether the received signal is an Ethernet OAM signal or a user frame. Ethernet OAM separation and termination unit 6020, if judging that the received signal is a user frame, transfers the same to the user device via IF unit 6010 which is an interface unit with the outside. Ethernet OAM separation and termination unit 6020, if judging that the received signal is an Ethernet OAM signal, transfers the same to Ethernet OAM processing unit 6060 inside terminal control unit 6040 without making a transfer to the user device. In Ethernet OAM processing unit 6060, the contents of the received Ethernet OAM signal is checked and necessary processing is performed.

Ethernet OAM processing unit 6060 reads the MEG level of the concerned signal from MEL item 3050 of the received Ethernet OAM signal and judges it to be Ethernet OAM signal transparency or termination. In the case where the MEG level of the Ethernet OAM signal is greater than the termination MEG level maintained by Ethernet OAM processing unit 6060, i.e. the MEG level that should be processed by Box-M 40, Ethernet OAM processing unit 6060 processes the Ethernet OAM signal transparently. This “transparent processing” is processing which folds back as is the Ethernet OAM signal transferred from Ethernet OAM separation and termination unit 6020 to Ethernet OAM separation and termination unit 6020 and folds back as is the Ethernet OAM signal sent from Ethernet OAM insertion and multiplexing unit 6030 to Ethernet OAM insertion and multiplexing unit 6030.

In the case where the MEG level of the Ethernet OAM signal is smaller than the MEG level maintained by Ethernet OAM processing unit 6060, Ethernet OAM processing unit 6060 destroys the Ethernet OAM signal.

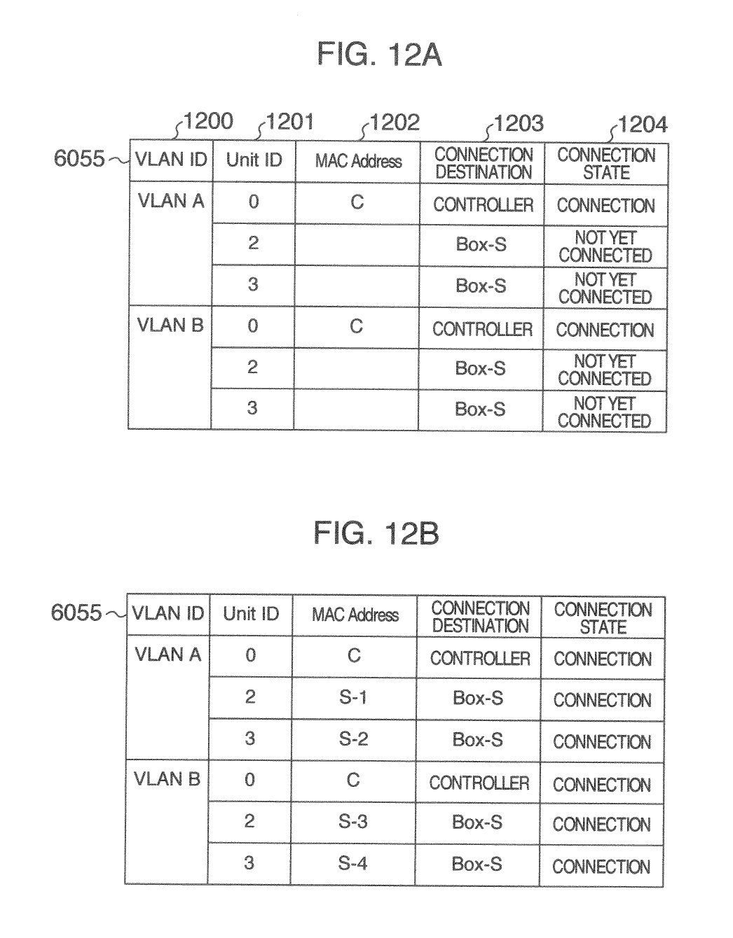

In the case where the MEG level of the Ethernet OAM signal is the same as the termination MEG level maintained by Ethernet OAM processing unit 6060, Ethernet OAM processing unit 6060 terminates the Ethernet OAM signal and carries out processing of the Ethernet OAM signal. At this time, if the Ethernet OAM signal received from L2-VPN network 10 is an Eth-CC signal, Ethernet OAM processing unit 6060 checks the source MAC address, the unit ID, or the information of control/user line judgment domain 4061 and expands the concerned information in connection destination table processing unit 6050. Connection destination table processing unit 6050 registers, as the need may be, the source MAC address or the like in connection destination DB 6055. Connection destination table processing unit 6050 ascertains the state of a Box-S 30 transferred from controller 50 and affiliated therewith and ascertains, on the basis of a source MAC address acquired from a received Eth-CC signal, or the like, the state of an opposite device connected therewith. Connection destination DB 6055 is a database for storing unit IDs and MAC addresses et cetera of connected opposite devices and will be subsequently described in FIG. 12.

Settings administration unit 6080 stores and administers registration information transferred from controller 50 to its own device. As for the registration information stored and administered by settings administration unit 6080, since box-M 40 is accommodated in two VLAN ID types, VLAN A and VLAN B, there is e.g. stored, in network 1, a unit ID of Box-S 30, or the like, which is an opposite device of both VLAN A and VLAN B. From the information transferred from controller 50, settings administration unit 6080 deploys the necessary information of the information regarding Box-S 30, subordinate thereto, and the like, to connection destination table administration unit 6050. Report monitoring unit 6070 is provided with a function of monitoring failure reports from other devices and failure situations inside its own device and reporting, as the need may be, controller 50, the opposite Box-S 30, or the like, of the information detected by its own device. In the concerned report, there may e.g. be emitted instructions to Ethernet OAM administration unit 6060 and generated Ethernet OAM reports signals necessary in Ethernet OAM administration unit 6060.

Inside report monitoring unit 6070, connectivity monitoring unit 6110 monitors the connectivity with controller 50 or other terminating devices. Connectivity monitoring unit 6110 carries out connectivity monitoring utilizing connection destination table administration unit 6050 and Ethernet OAM administration unit 6060. In other words, connectivity monitoring unit 6110, with reference to the database registered in connection destination DB 6055, monitors the connectivity with the concerned device by seeing whether Ethernet OAM processing unit 6060 receives an Eth-CC signal from controller 50 or the opposite terminating device within a fixed time interval.

If a signal is transmitted from a user device, Box-M 40 receives the same with frame buffer unit 6100 inside Ethernet OAM insertion and multiplexing unit 6030, via IF unit 6010. Ethernet OAM insertion and multiplexing unit 6030 has a function of judging whether the received signal is an Ethernet OAM signal or a user frame. If Ethernet OAM insertion and multiplexing 6030 judges that the received signal is a user frame, it transfers the signal to L2-VPN network 10 via IF unit 6000 which is an interface unit with the outside. If Ethernet OAM insertion and multiplexing unit 6030 judges that the received signal is an Ethernet OAM signal, transfers the same to Ethernet OAM processing unit 6060 inside terminal control unit 6040, without making a transfer to L2-VPN network 10. In this way, the terminating device of this embodiment is one that terminates the OAM signal as the need may be.

Terminal control unit 6040 brings together connection destination table administration unit 6050, settings administration unit 6080, report monitoring unit 6070, and Ethernet OAM processing unit 6060 and carries out control of its entire own device.

In the case where report information or an Eth-CC signal is transmitted from Box-M 40 to controller 50, since it is acceptable to transmit individually to controller 50, Box-M 40 sets destination MAC address 3000 to the MAC address of controller 50 and transmits with a unicast MAC address.

Moreover, in the case of transmitting an Eth-CC signal in order to carry out monitoring of the connectivity with Box-S 30 under its command, Box-M 40 sets destination MAC address 3000 to a multicast MAC address and transmits to each terminating device for each VLAN ID registered in the device itself. By transmitting the Eth-CC signal set in the multicast MAC address, it becomes possible for Box-M 40 to transmit together to a plurality of Box-S 30 under its command.

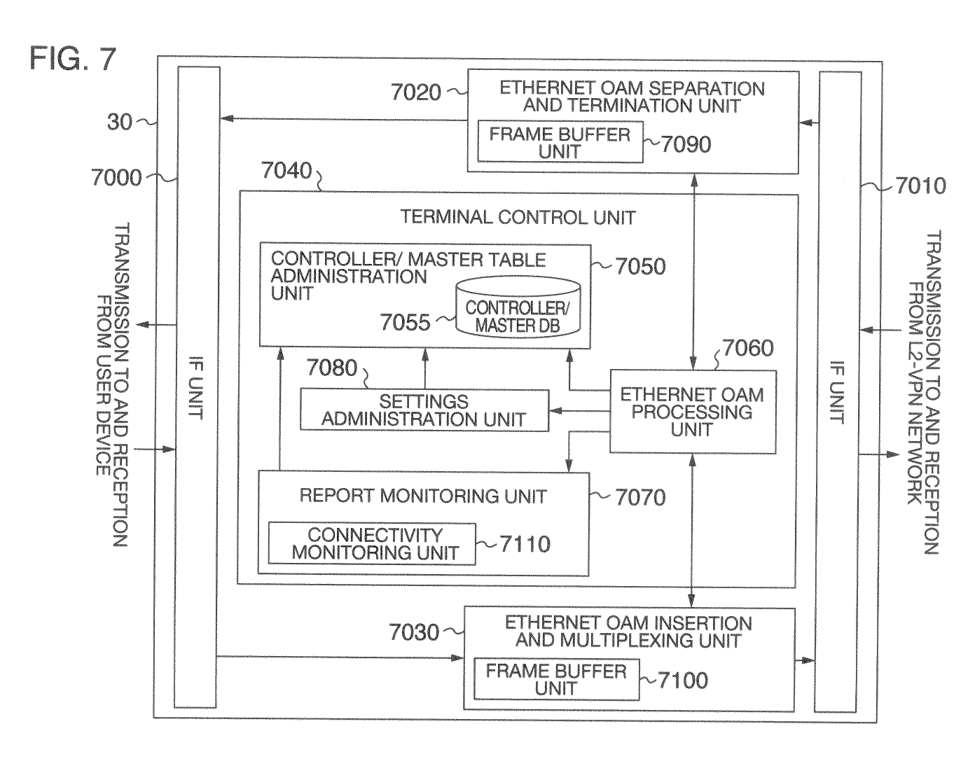

FIG. 7 is an example of a block diagram of terminating device Box-S 30 on the base point side.

Box-S 30 is e.g. composed of IF units 7000 and 7100, an Ethernet OAM separation and termination unit 7020, an Ethernet OAM insertion and multiplexing unit 7030, and a terminal control unit 7040. Terminal control unit 7040 is e.g. composed of a controller/master table administration unit 7050, an Ethernet OAM processing unit 7060, a report monitoring unit 7070, and a settings administration unit 7080. Report monitoring unit 7070 has e.g. a connectivity monitoring unit 7110 built in. In Ethernet OAM separation and termination unit 7020 and Ethernet OAM insertion and multiplexing unit 7030, there are e.g. buffer frames 7090 and 7100 built in. Controller/master table administration unit 7050 has e.g. a controller/master DB 7055 built in.

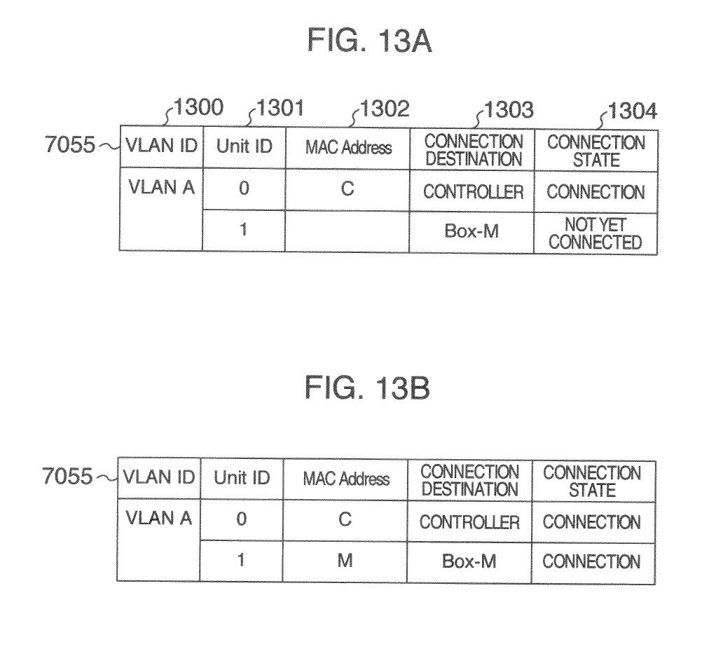

The details of each of the blocks apart from controller/master table administration unit 7050 and controller/master DB 7055 are the same as in the block diagram of Box-M 40 in FIG. 6, detailed description thereof will be omitted. Controller/master table administration unit 7050 is a substitute for the connection destination table administration unit 6050 of FIG. 6. Controller/master table administration unit 7050 has a function of administering the MAC addresses of controller 50 and Box-M 40 which are opposite devices. Regarding controller/master DB 7055, it will be subsequently described in FIG. 13.

Also, in the case where report information or an Eth-CC signal is transmitted from Box-S 30 to controller 50, since it is acceptable to transmit individually to controller 50, Box-S 30, sets, in the same way as Box-M 40, destination MAC address 3000 to the MAC address of controller 50 and transmits with a unicast MAC address. Additionally, even in the case of transmitting an Eth-CC signal for carrying out monitoring of the connectivity with the superordinate Box-M 40, Box-S 30, since it is acceptable to transmit only to superordinate Box-M 40, sets destination MAC address 3000 to the MAC address of Box-M 40 and transmits with a unicast MAC address.

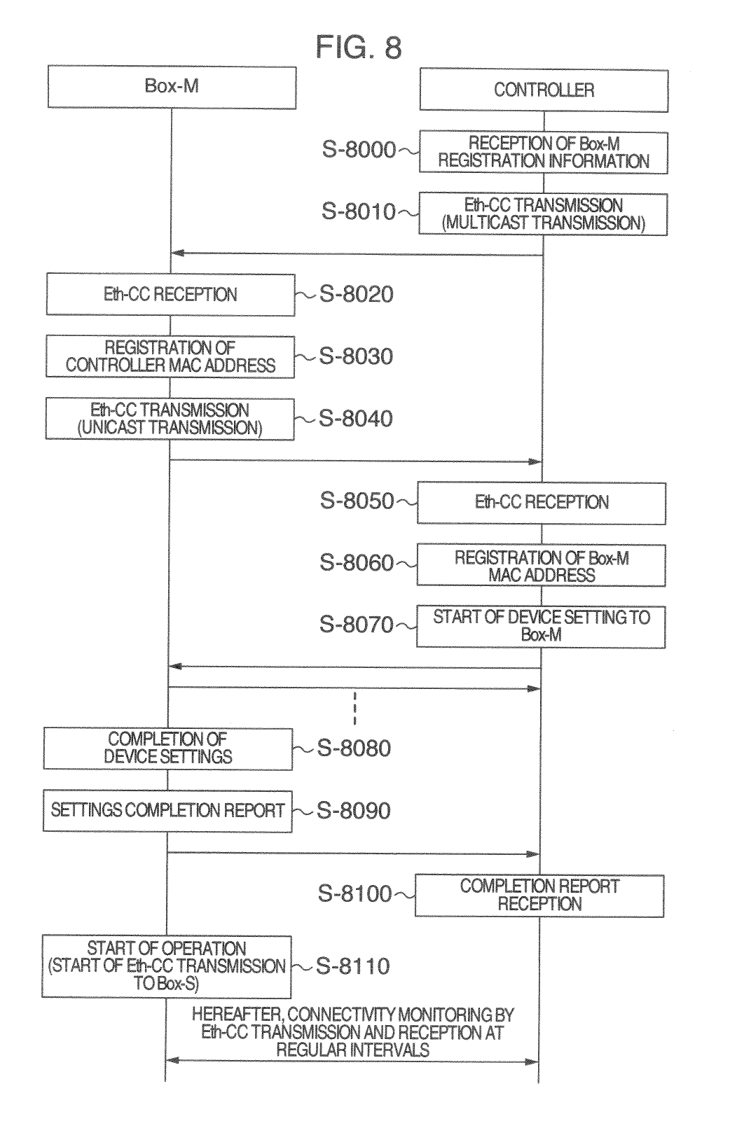

FIG. 8 is a sequence diagram related with the launch, in network 1, up to the point of normal operation performed between controller 50 and terminating device Box-M 40 on the center side.

Settings information pertaining to Box-M 40 which has been set in advance in controller 50 by the operator is registered in registration information DB 5055 (Step 8000). A subsequent description will be given in FIG. 11A regarding which information the operator registers in advance in registration information DB 5055.

As for controller 50, taking the opportunity that information has been registered in registration information DB 5055, Ethernet OAM generation unit 5030 thereof periodically transmits an Eth-CC signal to the L2-VPN network (Step 8010). At this time, destination MAC address 3000 within the Eth-CC signal is taken to be a multicast address. By setting destination MAC address 3000 to be a multicast MAC address, it becomes possible to together bring the Eth-CC signal to base point side terminating device Box-S 30, to be subsequently described, as well.

Further, in the case of carrying out the transmission of the Eth-CC signal by multicast, it is possible to utilize a multicast MAC address for OAM frames specified in Non-patent Reference 1. If this multicast MAC address is used, the terminating devices receiving the Eth-CC signal, it is possible to check that the multicast MAC address specified in the standard is stored in destination MAC address 3000 and do the processing.

Also, in Non-patent Reference 1, the multicast MAC address used with the Ethernet OAM signal differs depending on the MEG level. In the aforementioned example, if the MEG level is “3”, the multicast MAC address is “0x01-0x80-0xC2-0x00-0x00-0x33” and if the MEG level is “4”, the multicast MAC address is “0x01-0x80-0xC2-0x00-0x00-0x34”. This MAC address is also applied to the Eth-CC signal. However, the set value of the MEG level is not one related with the previous description, it being but an example. In the present embodiment, depending on the narrowness of the segment transmitting and receiving the Eth-CC frames, there are also cases where the used multicast MAC addresses differ.

In addition, it is also acceptable to use a multicast MAC address decided arbitrarily by the user or the carrier, not a MAC address specified in a standard described above. In the case of using an arbitrary multicast MAC address, it is necessary to set in advance which multicast MAC address is used to transmit and receive the Eth-CC signal in controller 50, Box-M 40, and Box-S 30.

Box-M 40, having received an Eth-CC signal from controller 50, judges that the concerned signal is an Ethernet OAM signal in Ethernet OAM separation and termination unit 6020 (Step 8020). Thereafter, Ethernet OAM processing unit 6060 judges that the concerned signal is an Eth-CC signal and, by further referring to control/user line judgment domain 4061, that it is an Eth-C signal from controller 50.

At the time of receiving the Eth-CC signal from controller 50 after launch (Step 8020), box-M 40 or Box-S 30 does not acquire information pertaining to a terminating device other than the controller or the device itself. Accordingly, Box-M 40 or Box-S 30 use control/user line judgment domain 4061 for judging the type of the transmission source of the received Eth-CC signal.

As described in FIG. 4, when controller 50 takes a multicast MAC address to be destination MAC address 3000 and transmits an Eth-CC signal, control/user line judgment domain 4061 is set to “1”. Also, when a terminating device transmits an Eth-CC signal, control/user line judgment domain 4061 is set to “0”. For this reason, even if Box-M 40 receives an Eth-CC signal in which a MAC address that is not known by the device itself is stored in source MAC address 3010, it is possible to judge that this signal is one that comes from controller 50 if it is checked that a “1” is stored in control/user line judgment domain 4061.

Box-M 40, if checking an Eth-CC signal from controller 50, registers source MAC address 3010 from the concerned Eth-CC signal in connection destination DB 6055 (Steps 8020 and 8030). Due to this processing, it becomes possible for Box-M 40 to recognize the MAC address of controller 50. At the same time, Box-M 40 is able to recognize the VLAN ID configured with controller 50 from VLAN tag 3020 within the received Eth-CC signal.

When the MAC address of controller 50 is registered in connection destination DB 6055, terminal control unit 6040 of Box-M 40 emits an instruction to periodically transmit an Eth-CC signal in which the MAC address (unicast MAC address) of concerned controller 50 is set as destination MAC address 3000 in Ethernet OAM insertion and multiplexing unit 6030 (Step 8040). By acquiring source MAC address 3010 in the Eth-CC signal from controller 50, Box-M 40 becomes able to transmit the Eth-CC signal to aforementioned controller 50.

Further, in the Eth-CC signal transmitted by Box-M 40 to controller 50, the serial number of Box-M 40 is stored in serial number 4062.

Ethernet OAM termination and processing unit 5040 of controller 50, having received an Eth-CC signal from Box-M 40 recognizes the concerned signal to be an Eth-CC signal and transfers the concerned signal to registration information administration unit 5050. Registration information administration unit 5050 launches a query to registration information DB 5055 about serial number 4062 within the concerned signal. When registration information administration unit 5050 reconciles the queried serial number 4062 with a serial number 1102 of Box-M 40, registered within the registration information, it registers source MAC address 3010 of the concerned Eth-CC signal as a MAC address 1103 of Box-M 40 (Steps 8050 and 8060).

After registration of the aforementioned MAC address, controller 50, without interruption, gradually carries out settings necessary for normal operation to the concerned Box-M 40 (Step 8070).

Box-M 40 registers settings information transmitted from controller 50 in settings administration unit 6080 and progressively carries out processing necessary for normal operation. When settings necessary for normal operation have been completed, Box-M 40 switches over to normal operation (Steps 8080, 8090, 8100, and 8110).

Thereafter, using Eth-CC signals mutually transmitted and received periodically to and from Box-M 40 and controller 50, controller 50 and Box-M 40 mutually carry out connectivity monitoring mutually. Also, the details thereof will be described subsequently but since, in the settings information received from controller 50 (Step 8070), there is also included information to the effect that Box-M 40 is a higher-level device (master) with respect to the other terminating devices, Box-M 40, having switched over to normal operation, periodically transmits an Eth-CC signal to Box-S 30 (Step 8110). At this point, since Box-M 40 cannot yet check the connectivity with all Box-S 30 under its command, regarding the connectivity with all Box-S 30 under its command, it switches over to normal operation in a state in which it has been judged that there is a connectivity anomaly.

Here, in network 1, Box-M 40 is respectively connected with networks subordinate to networks having VLAN IDs VLAN A and VLAN B. Also, controller 50 periodically transmits, on the basis of registration information DB 5055, two types of Eth-CC signals having VLAN tags 3020 VLAN A and VLAN B. Accordingly, Box-M 40 receives the aforementioned two types of Eth-CC signals from controller 50 and learns the respective VLAN IDs. And then, it generates two types of Eth-CC signal with respective VLAN IDs stored in VLAN tag 3020 and transmits the same to controller 50. At this point, for subsequent registration information reports to Box-M 40, it does not matter if controller 50 transfers registration information using any of the previously mentioned VLAN IDs or transfers the registration information inside the affiliated VLANs for each VLAN.

Also, for the transfer of settings information to Box-M 40 (Step 8070), it becomes possible, e.g., to have settings information stored in an appropriate domain of the VSM (Vendor Specific OAM Message) signal for which it is possible to set the header independently and with OpCode 3070 set to “0x33”, and for controller 50 to transfer the same to Box-M 40. In addition, it does not matter if the settings information is registered in Box-M 40 in other ways as well, from the outside. E.g., on the occasion of a construction contractor's installing a Box-M 40, it does not matter if the settings information is transferred to Box-M 40 from a dedicated registration terminal possessed by the construction contractor.

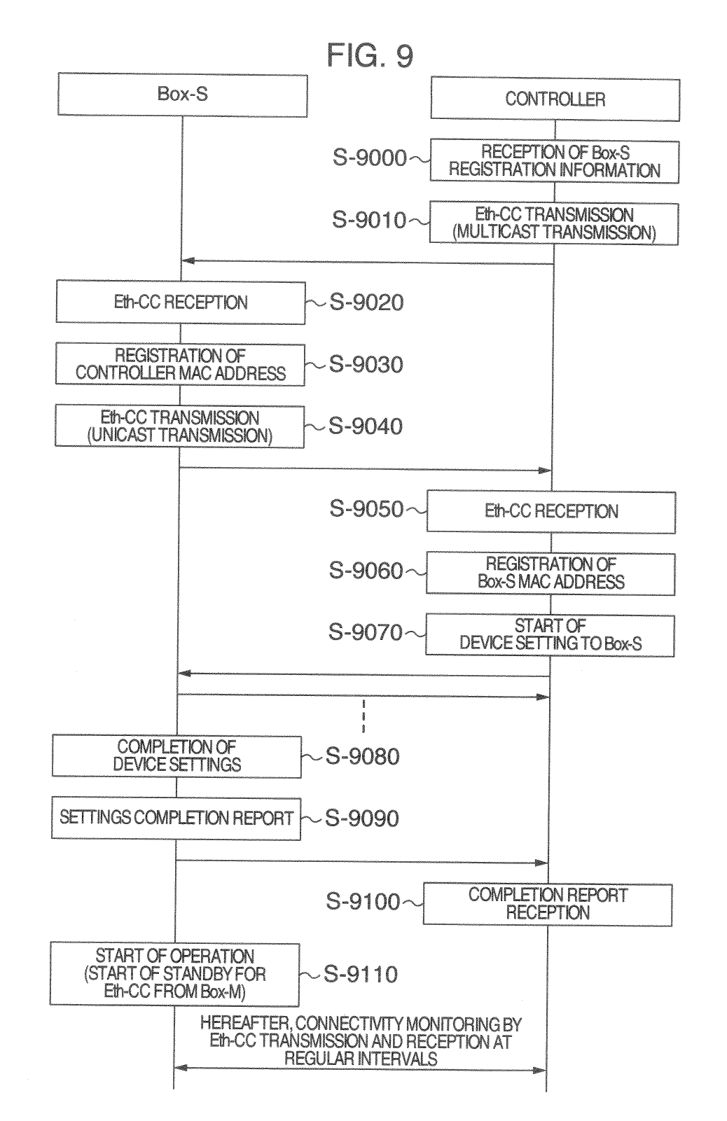

FIG. 9 is a sequence diagram pertaining to a launch up to normal operation, which is carried out in network 1 between controller 50 and terminating device Box-S 30 on the base point side.

Regarding the processing contents at this time, a detailed description will be omitted, since it is the same processing as between aforementioned controller 50 and terminating device Box-M 40 on the center side. However, the functioning after the settings necessary for normal operation with respect to Box-S 30 have come to an end differs between a Box-S 30 and a Box-M 40. Since information to the effect that Box-S 30 is a lower-level device (slave) with respect to the other terminating devices is included in the settings information received from controller 50 (Step 9070), Box-S 30, on the occasion of switching over to normal operation, does not transmit Eth-CC signals to other terminating devices but takes the action of being on standby for an Eth-CC signal (Step 9110) from the master terminating device (Box-M 40 in this embodiment).

Regarding the communication between controller 50 and Box-S 30, connectivity monitoring is started by mutually transmitting and receiving Eth-CC signals at fixed intervals. Further, in the Eth-CC signal transmitted by Box-M 40 to controller 50, the serial number of Box-S 30 is stored in serial number 4062. When controller 50 receives an Eth-CC signal from Box-S 30 for the first time, since it does not know the MAC address of Box-S 30, it compares this serial number 4062 with serial number 1102 of registration information DB 5055, the identification of the Box-S 30 from which the signal has been received being the same as the processing between Box-M 40.

Since Box-S 30, while waiting for the Eth-CC signal from Box-M 40, is not yet able to check the connectivity with the superordinate Box-M 40, it switches over to normal operation in a state judged to have a connectivity anomaly regarding the connectivity with Box-M 40.

Also, for the transfer of settings information to Box-S 30, communication from controller 50 is utilized, but it does not matter if the settings information is registered from the outside in other ways as well. E.g., it does not matter if, on the occasion of a construction contractor's installing a Box-S 30, the settings info is transferred to Box-S 30 from a dedicated registration terminal possessed by the construction contractor.

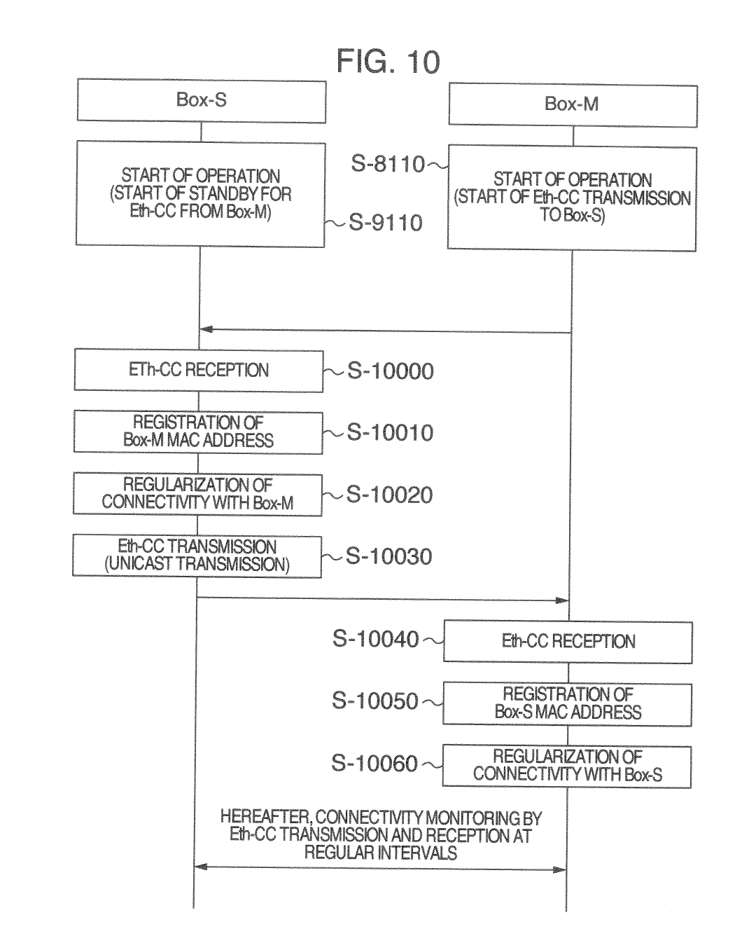

FIG. 10 is a sequence diagram up to the point of connectivity monitoring implementation in network 1 performed between terminating device Box-M 40 on the center side and terminating device Box-S 30 on the base point side. As mentioned above, since Box-M 40 and Box-S 30 are mutually unable to receive an Eth-CC signal, it is judged that there is an anomaly in the connectivity with a device that is opposite to both of them and there is a switchover to normal operation.

As mentioned above, Box-M 40, having switched over to normal operation, starts transmission of Eth-CC signals to Box-S 30 at regular intervals for each VLAN ID (Step 8110 in FIG. 8), since it is reported from controller 50 that it itself is the master (Step 8070 of FIG. 8). Moreover, Box-S 30, having switched over to normal operation, is on standby until receiving an Eth-CC signal from Box-M 40, as described above (Step 9110 of FIG. 9).

At this point, destination MAC address 3000 of the concerned Eth-CC signal has a multicast MAC address set which is predetermined by a standard, or by the carrier or the user. Accordingly, in network 1, the Eth-CC signal for which the VLAN ID is set to VLAN A is received by Box-S-1 30A and Box-S-2 30B and the Eth-CC signal for which the VLAN ID is set to VLAN B is received by Box-S-3 30C and Box-S-4 30D.

Also, Box-M 40, in unit ID 4063 of the Eth-CC signal received using a multicast MAC address, there is stored the unit ID of Box-M 40 set from controller 50.

Box-S 30, having received an Eth-CC signal from Box-M 40, judges the concerned signal to be an Eth-CC signal in Ethernet OAM termination and separation unit 7020 and judges that the concerned signal is an Eth-CC signal received from Box-M 40 in Ethernet OAM processing unit 7060 (Step 10000).

By checking control/user line judgment domain 4061 of the received Eth-CC signal, Ethernet OAM processing unit 7060 is able to judge which of controller 50 and Box-M 40 transmitted the Eth-CC signal. Ethernet OAM processing unit 7060, having judged that the concerned signal is an Eth-CC signal from Box-M 40, next transfers the information about the unit ID and the information about source MAC address 3010, within the concerned signal , to controller/master table administration unit 7050. Controller/master table administration unit 7050, using controller/master DB 7055, designates Box-M 40 of the transmission source. In the designation of the transmission source Box-M 40, information about the transferred unit ID is utilized.

In controller/master DB 7055, there is generated table information (the table being generated utilizing settings information transmitted by controller 50 in Step 9070 in FIG. 9) pertaining to the destination of the connection with itself, generated at the time of the launch of normal operation, and as for Box-S 30, the unit ID of Box-M 40 is set from controller 50, so on the basis hereof, it is possible to designate the terminating device of the transmission source. As a result of the designation of the terminating device, controller/master table administration unit 7050 judges that the concerned Eth-CC signal is an Eth-CC signal Box-M 40 which is superordinate. Thereafter, controller/master table administration unit 7050 registers source MAC address 3010 of the concerned signal in controller/master DB 7055 (Step 10010). At this point, Box-S 30 judges that a connection with the opposite Box-M 40 has been established and cancels the connectivity anomaly (Step 10020). Thereafter, the same Box-S 30 starts to transmit Eth-CC signals at regular intervals to Box-M 40 (Step 10030).

At this point, there is stored the unit ID of Box-S 30 in Unit ID 4063 of the Eth-CC signal transmitted by Box-S 30 to Box-M 40.

At this time, Box-S 30 uses source MAC address 3010 of the Eth-CC signal registered, as previously described, and received from Box-M 40 for the destination MAC address 3000 of the Eth-CC signal bound for Box-M 40. In other words, the destination MAC address of the Eth-CC signal transmitted by Box-S 30, being a unicast MAC address, differs from that of the Eth-CC signal transmitted by Box-M 40 and can be received by the concerned Box-M 40 only.

The previously described Eth-CC signal, transmitted from Box-S 30, is received in Ethernet OAM separation and termination unit 6020 of Box-M 40 (Step 10040). The concerned signal is judged to be an Ethernet OAM signal Ethernet OAM separation and termination unit 6020 and is transferred to Ethernet OAM processing unit 6060. Ethernet OAM processing unit 6060, if confirming that the concerned signal is an Eth-CC signal, checks without interruption the control/user line judgment domain and judges that it is an Eth-CC signal not from controller 50 but from the terminating device. Ethernet OAM processing unit 6060, when carrying out the aforementioned judgment, deploys the unit ID information of the terminating device which is the transmission source extracted from the concerned signal and the information about source MAC address 3010 to connectivity table administration unit 6050.

Connectivity table administration unit 6050, in the same way as Box-S 30, takes the aforementioned unit ID to be a search key, searches connection destination DB 6055, and designates a transmission source device. The Box-M 40 designated as the transmission source device registers source MAC address 3010 of the concerned signal in connection destination DB 6055 (Step 10050). Box-M 40 at this point judges that the connection with the concerned Box-S 30 has been established and cancels the connectivity anomaly (Step 10060).

By utilizing Eth-CC signals transmitted and received mutually at regular intervals after having mutually learnt the MAC addresses, Box-M 40 and Box-S 30 are able to carry out connectivity monitoring.

FIGS. 11A and 11B are examples of table information stored in registration information DB 5055 of controller 50.

E.g., in network 1, the MAC address of Box-M 40 is taken to be “M”, the serial number is taken to be “0001”, the affiliated VLAN IDs are taken to be “VLAN A” and “VLAN B”, the unit ID in VLAN A is taken to be “1”, and the unit ID in VLAN B is taken to be “1”. Also, the MAC address of Box-S-1 30A is taken to be “S-1”, the serial number is taken to be “0002”, the affiliated VLAN ID is taken to be “VLAN A”, and the unit ID in VLAN A is taken to be “2”. Moreover, the MAC address of Box-S-2 30B is taken to be “S-2”, the serial number is taken to be “0003”, the affiliated VLAN ID is taken to be “VLAN A”, and the unit ID in VLAN A is taken to be “3”. In addition, the MAC address of Box-S-3 30C is taken to be “S-3”, the serial number is taken to be “0004”, the affiliated VLAN ID is taken to be “VLAN B”, and the unit ID in VLAN B is taken to be “2”. Also, the MAC address of Box-S-4 30D is taken to be “S-4”, the serial number is taken to be “0005”, the affiliated VLAN ID is taken to be “VLAN B”, and the unit ID in VLAN B is taken to be “3”.

As described above, controller 50 receives registration information about terminating devices Box-M 40 and Box-S 30 from an operator (Step 8000 in FIG. 8 and Step 9000 in FIG. 9). FIG. 11A is an example of information registered in advance in registration information DB 5055 by controller 50 at this time. E.g., as first settings information, VLAN IDs 1100 of Box-M 40 and Box-S 30 to be connected, unit IDs 1101 and serial numbers 1102 inside the VLAN, a terminating device class 1105, and unit IDs 1106 of connection destination terminating device are registered from the operator.

Here, the term “terminating device class” refers e.g., if what is concerned is Box-M 40, to a higher-level device governing Eth-CC signals from Box-S 30, another terminating device; i.e. it is information to the effect that it is a master and is registered as “Box-M” in FIGS. 11A and 11B. Similarly, if what is concerned is Box-S 30, it refers to a lower-level device which is subordinate to Box-M 40, another terminating device; i.e. it is information to the effect that it is a slave and is registered as “Box-S” in FIGS. 11A and 11B.

Controller 50, if receiving an Eth-CC signal from a terminating device (Step 8050 in FIG. 8 and Step 9050 in FIG. 9), designates the transmission source device from the settings information in FIG. 11A. That is to say that, as described above, controller 50 takes as a search key serial number 4062 of the terminating device, included in the received Eth-CC signal, searches registration information DB 5055, and is able to designate from which device the Eth-CC signal was received. When the transmission source terminating device becomes known, controller 50 registers source MAC address 3010 of the same Eth-CC signal in MAC address 1103 corresponding to serial number 1102 designated inside registration information DB 5055.

Thereafter, controller 50 transfers, to the terminating devices whose MAC addresses it has registered, settings information such as unit ID 1101, terminating device class 1105, unit ID 1106 of the connection destination device, and device class 1105 of the connection destination device for each VLAN ID of the same terminating devices, and makes the terminating devices switch over to normal operation (Step 8070 in FIG. 8 and Step 9070 in FIG. 9).

E.g., in the case where controller 50 transfers settings information to Box-M 40, it is possible, taking the serial number “0001” of Box-M 40 to be the search key, to report VLAN A and VLAN B as affiliated VLAN ID 1100; to report, as unit ID 1101, “1” for VLAN A and “1” for VLAN B; to report terminating device Box-M on the center side for both VLAN A and B as terminating device class information 1105; to report, as Unit ID 1106 of the connection destination device, unit IDs “2” and “3” for VLAN A and unit IDs “2” and “3” for VLAN B; and to report, as connection destination device class in VLAN A, a terminating device Box-S on the base point side for unit ID “2” and a terminating device Box-S on the base point side for unit ID “3” and in VLAN B, a terminating device Box-S on the base point side for unit ID “2” and a terminating device Box-S on the base point side for unit ID “3”.

In Box-M 40, information pertaining to the connection destination reported from controller 50 is registered in connection destination DB 6055 and, in Box-S 30, stored in controller/master DB 7055. Controller 50, when making all of the terminating devices under its command switch over consecutively to normal operation, the information of FIG. 11B is held in registration information DB 5055. In other words, if one compares with the initial state of FIG. 11A, in FIG. 11B, new information is registered in MAC address 1103 and operating state 1104.

Controller 50, on the occasion of receiving Eth-CC signals from Box-M 40 and Box-S 30 having switched over to normal operation, judges the connection regularity with the concerned devices by querying in the concerned table information the source MAC addresses of the concerned Eth-CC signals.

Also, in the case where e.g. Box-M 40 or Box-S 30 have a device exchange due to a failure, it is e.g. acceptable for the operator to take over the existing information as is without modifying unit ID 1101 in the concerned table information, to modify (overwrite) the serial number of the concerned device, and to delete the MAC address of the concerned device. By carrying out the aforementioned process, controller 50 acquires anew the MAC address of Box-M 40 or Box-S 30 after exchange and, by carrying out anew a transfer of the registration information (registration information with the same contents as those registered in the terminating device before exchange) to the concerned device, makes the concerned device switch over to normal operation and starts monitoring of the connectivity with the concerned device. By means of the aforementioned process, controller 50 does not anymore lay down erroneous connectivity anomaly judgments that are due to the fact that Eth-CC signals from Box-M 40 or Box-S 30 before the exchange do not reach it anymore.

Further, FIGS. 11A and 11B are only an example and it does not matter if information that is necessary for the construction of the concerned network, such as e.g. bandwidth information or the like that applies to the concerned device, is suitably added or corrected.

FIGS. 12A and 12B are an example of connection destination DB 6055 table information that is generated by Box-M 40 for the purpose of connectivity judgments. In connection destination DB 6055, there is e.g. stored, for each VLAN ID 1200, information about a unit ID 1201, a MAC address 1202, a connection destination class 1203, or a connection state 1204, of the connected controller 50 or Box-S 30 under its command.

Box-M 40, after launch, receives for the first time an Eth-CC signal from controller 50 (Step 8020 in FIG. 8) by judging control/user line judgment domain 4061 of the concerned Eth-CC signal, designates the concerned Eth-CC signal to be an Eth-CC signal from controller 50, and registers source MAC address 3010 (taking it to be “C”) of this Eth-CC signal as MAC address 1202 of controller 50 (Step 8030 in FIG. 8). Also, from VLAN tag 3020 of the Eth-CC signal received from controller 50, it is also possible to register VLAN ID 1200 for the space shared with controller 50. In addition, from control/user line judgment domain 4061 of the Eth-CC signal, it is also possible to register information to the effect that connection destination class 1203 is “controller”.

Thereafter, by receiving settings information from controller 50 (Step 8070 in FIG. 8), Box-M 40 switches over to normal operation (Step 8110 in FIG. 8). As for the information pertaining to Box-S 30 under command, obtained from the settings information of FIGS. 12A and 12B, is that Box-S 30 is a connection destination and is a slave (1203) and is unit ID 1201 or VLAN ID 1200 of Box-S 30. Also, even though it is not stated in FIGS. 12A and 12B, since controller 50 also transmits device class 1105 of Box-M 40 to Box-M 40, Box-M 40 ascertains that the device itself is a higher-level device (master) among the terminating devices.

At this time, just after the switchover, Box-M 40 has table information such as shown in FIG. 12A. In other words, just after the switchover, Box-M 40 obtains sufficient information regarding controller 50 by means of the reception of Eth-CC signals (Step 8020 in FIG. 8) and the reception of settings information (Step 8070 in FIG. 8), but regarding Box-S 30 under its command, even though information from controller 50 is furnished, by means of the reception of settings information from controller 50 (Step 8070 in FIG. 8), about the fact that it is a connection destination 1203 and about VLAN ID 1200, unit ID 1201, and connection destination class 1203, MAC address 1202 is not registered and since connection state 1204 has no MAC address registered, the state is “Not yet connected”, and a connection anomaly is detected.

Further, in FIGS. 12A and 12B, unit ID 1201 of controller 50 has taken on the value “0”, but it does not matter if this information is loaded inside the Eth-CC signal transmitted by controller 50 nor does it matter if it is included in the settings information (Step 8070 in FIG. 8) transmitted from controller 50 to Box-M 40 or if it is pre-defined as a system and known (registered) in advance by Box-M 40. In any event, it does not matter if unit ID 1201 is an ID set uniquely inside the VLAN.

Thereafter, when Box-M 40 receives an Eth-CC signal from each accommodated Box-S 30 (Step 10040 in FIG. 10), it utilizes unit ID 4063 inside the Eth-CC signal and queries connection destination DB 6055 for designating the terminating device. When it establishes the transmission source terminating device as a result of querying unit ID 1201 of connection destination DB 6055, Box-M 40 processes the registration of source MAC address 3010 of the concerned Eth-CC signal in MAC address 1202 of the concerned table information (Step 10050 in FIG. 10). By the aforementioned registration processing completion, Box-M 40 judges that the connection with the concerned Box-S 30 has been completed, makes the connection state switch over from “Not yet connected” to “Connection”, modifies the connectivity anomaly judgment, and makes the judgment “Regular Connectivity” (Step 10060 in FIG. 10).

FIG. 12B is connection destination DB 6055 table information for a state in which the registration processing of all connection destination MAC addresses has been completed by Box-M 40 in network 1. By querying, in the concerned table information, the source MAC address of the concerned Eth-CC signal on the occasion of receiving an Eth-CC signal from controller 50 or a Box-S 30 having switched over to normal operation, Box-M 40 judges that there is connection regularity.

Also, in the case where e.g. controller 50 has a device exchange due to a failure, the MAC address of controller 50 ends up being modified. It is possible for Box-M 40 to distinguish an Eth-CC signal coming from controller 50 from a control/user line judgment domain 4061. Accordingly, Box-M 40, by modifying (overwriting) the aforementioned MAC address as the MAC address of controller 50 in the concerned table information if the source MAC address inside the Eth-CC signal coming from controller 50 is modified without any need for particular manipulation from the operator, either, so Box-M 40 also becomes capable of handling a modification (exchange) of controllers 50.

By the overwriting of a MAC address in this way, it is eliminated that Box-M 40 erroneously lays down a connectivity anomaly judgment even if the Eth-CC signal from controller 50 before the exchange does not arrive anymore, since the MAC address of the failed controller 50 that should be queried from connection destination DB 6055 has disappeared. Further, Unit ID 1201 is able to use the same value before and after the exchange of the device.

In addition, as for Box-M 40, in the case where there has been a device exchange of a Box-S 30 (e.g. Box-S-1 30 A) connected therewith due to a failure or the like, the system is devised so that it receives, from Box-S-1 30 A after the exchange, an Eth-CC signal in which the unit ID is unchanged but the source MAC address differs. This is because, in the case of a device exchange, the terminating device itself is exchanged but as for the settings information in the concerned terminating device, information that is the same as before the exchange is applied (transferred to the terminating device after the exchange from controller 50) to the terminating device after the exchange.

In this case, it becomes possible for Box-M 40, by modifying (overwriting) MAC address 1203 corresponding to the concerned unit ID 1201 (the unit ID of FIG. 12B being “2”) in the table information of FIG. 12B, to respond without any need for particular manipulation by the operator. In other words, it is acceptable to just leave unit ID 1201 diverted as “2” and overwrite MAC address 1203. By this processing, the Eth-CC signal from Box-S 30 before the exchange does not arrive anymore, but since the MAC address of Box-S 30 before the exchange has disappeared from connection destination DB 6055, so it is eliminated that Box-M 40 lays down connectivity anomaly judgment erroneously.

Further, FIGS. 12A and 12B are just an example and it does not matter if information necessary for the concerned table information is suitably added or corrected.

FIGS. 13A and 13B are an example of table information of controller/master DB 7055 of Box-S 30 for the purpose of connectivity judgment. In FIGS. 13A and 13B, there is given a description regarding in particular a configuration example of controller/master DB 7055 of Box-S-1 30A or Box-S-2 30B, affiliated with VLAN A of network 1. As for the concerned table information, there is e.g. stored information about unit ID 1301, MAC address 1302, connection destination class 1303, and connection state 1304, of the connected controller 50 and superordinate Box-M 40, for each VLAN ID 1300.

Directly after launch, Box-S 30, in the same way as Box-M 40, receives an Eth-CC signal (Step 9020 in FIG. 9) from controller 50 and, by judging control/user line judgment domain 4061 of the concerned Eth-CC signal, designates the concerned Eth-CC signal to be the Eth-CC signal from controller 50 and registers source MAC address 3010 of this Eth-CC signal as MAC address 1302 of controller 50 (Step 9030 in FIG. 9). Also, from VLAN tag 3020 of the Eth-CC signal received from controller 50, it becomes possible to also register VLAN ID 1300 for the space shared with controller 50. In addition, from control/user line judgment domain 4061 of the Eth-CC signal, it is possible to also register information to the effect that connection destination class 1303 is “controller”.

Thereafter, by receiving settings information from controller 50 (Step 9070 in FIG. 9), Box-S 30 switches over to normal operation (Step 9110 in FIG. 9). The information pertaining to Box-M 40, which is superordinate, from the settings information in FIGS. 13A and 13B, is that Box-M 40 is superordinate and is a master (1303) and is unit ID 1301 and VLAN ID 1300 of Box-M 40. Also, it is not mentioned in FIGS. 13A and 13B, but since controller 50 also transmits Box-S 30 device class 1105 to Box-S 30, Box-S 30 ascertains that it itself is a lower-level device (slave) among the terminating devices.

At this time, directly after the switchover, Box-S 30 holds table information such as in FIG. 13A. In other words, Box-S 30 directly after the switchover has obtained sufficient information regarding controller 50 by means of the reception of Eth-CC signals (Step 9020 in FIG. 9) and the reception of settings information (Step 9070 in FIG. 9), but regarding superordinate Box-M 40, even though information about VLAN ID 1300, unit ID 1301, and connection destination class 1303 is provided from controller 50 due to the reception of settings information from controller 50 (Step 9070 in FIG. 9), a connection anomaly is detected, since MAC address 1302 is not yet registered and connection state 1304 does not have a MAC address registered, being “Not yet connected”.

Further, in FIGS. 13A and 13B as well, similarly to FIGS. 12A and 12B, unit ID 1301 of controller 50 has taken on the value “0”, but it does not matter if this information is provided inside the Eth-CC signal transmitted by controller 50 nor does it matter if it is included (Step 9070 in FIG. 9) in the settings information transmitted from controller 50 to Box-S 30 or if it is pre-defined as a system and known (registered) in advance by Box-S 30. In any event, it does not matter if unit ID 1301 is an ID that is set uniquely inside the VLAN.

Thereafter, since the process is the same as for Box-M 40, the description thereof is simplified, but if Box-S 30 receives an Eth-CC signal from Box-M 40 (Step 10000 in FIG. 10), it checks control/user line judgment domain 4061, judges the concerned signal to be an Eth-CC signal from the terminating device, compares unit ID 4063 included in the concerned signal with unit ID 1301 of controller/master DB 7055, and designates the signal to be an Eth-CC signal from Box-M 40.

Box-S 30, if designating the transmission source of the Eth-CC signal to be Box-M 40, registers source MAC address 3010 of the concerned Eth-CC signal in the domain of MAC address 1302 of controller/master DB 7055 (Step 10010 in FIG. 10). By completion of the aforementioned registration process, Box-S 30 judges that the connection with the concerned Box-M 40 has been completed, makes the connection state switch over from “Not yet connected” to “Connection”, and modifies the connectivity anomaly judgment to make a “Regular Connectivity” judgment (Step 10020 in FIG. 10).

Subsequently, Box-S 30 uses MAC address 1302 of Box-M 40 and transmits an Eth-CC signal at regular intervals to Box-M 40. Also, if the MAC address of controller 50 is registered, Box-S 30 uses the same MAC address 1302 and transmits Eth-CC signals at regular intervals to controller 50. In the unit ID 4063 of these Eth-CC signals, there is stored the unit ID of Box-S 30.

FIG. 13B shows table information about a state in which the registration processing of all connection destination MAC addresses has been completed in VLAN A of network 1 with Box-S-1 30A or Box-S-2 30B. On the occasion of receiving an Eth-CC signal from controller 50 or a Box-M 40 having switched over to normal operation, Box-S 30, by querying the source MAC address of the concerned Eth-CC signal in the concerned table information, judges that there is connection regularity.

Also, in the case where e.g. controller 50 has a device exchange due to a failure, the MAC address of controller 50 ends up being modified. At this point, Box-S 30, by carrying out the same processing as that, previously mentioned, of Box-M 40, it becomes possible, even without any particular manipulation from the operator, for Box-S 30 to also respond to a modification (exchange) of controller 50. In this case, the Eth-CC signal from controller 50 before the exchange does not arrive, but it is eliminated that Box-S 30 lays down a connectivity anomaly judgment erroneously.

In addition, as for Box-S 30, in the case where there has been a device exchange of a Box-M 40 connected therewith due to a failure or the like, the system is devised so that it receives, from Box-M 40 after the exchange, an Eth-CC signal in which the unit ID is the same as before but source MAC address 3010 differs. This is because, in the case of a device exchange, the terminating device is exchanged but as for the settings information in the concerned terminating device, the same info as before the exchange is applied (transferred from controller 50 to the terminating device after the exchange) to the terminating device after the exchange. In this case, by modifying (overwriting)) MAC address 1302 corresponding to ( ) the concerned unit ID 1301 in the table information of FIG. 13B, it becomes possible for Box-S 30 to respond without the need for any particular manipulation from the operator. According to the aforementioned process, the Eth-CC signal from Box-M 40 before the exchange does not arrive, but it is eliminated that Box-S 30 lays down a connectivity anomaly judgment erroneously.

In addition, FIGS. 13A and 13B are only an example and it does not matter if information necessary for the concerned table information is suitably added or corrected.

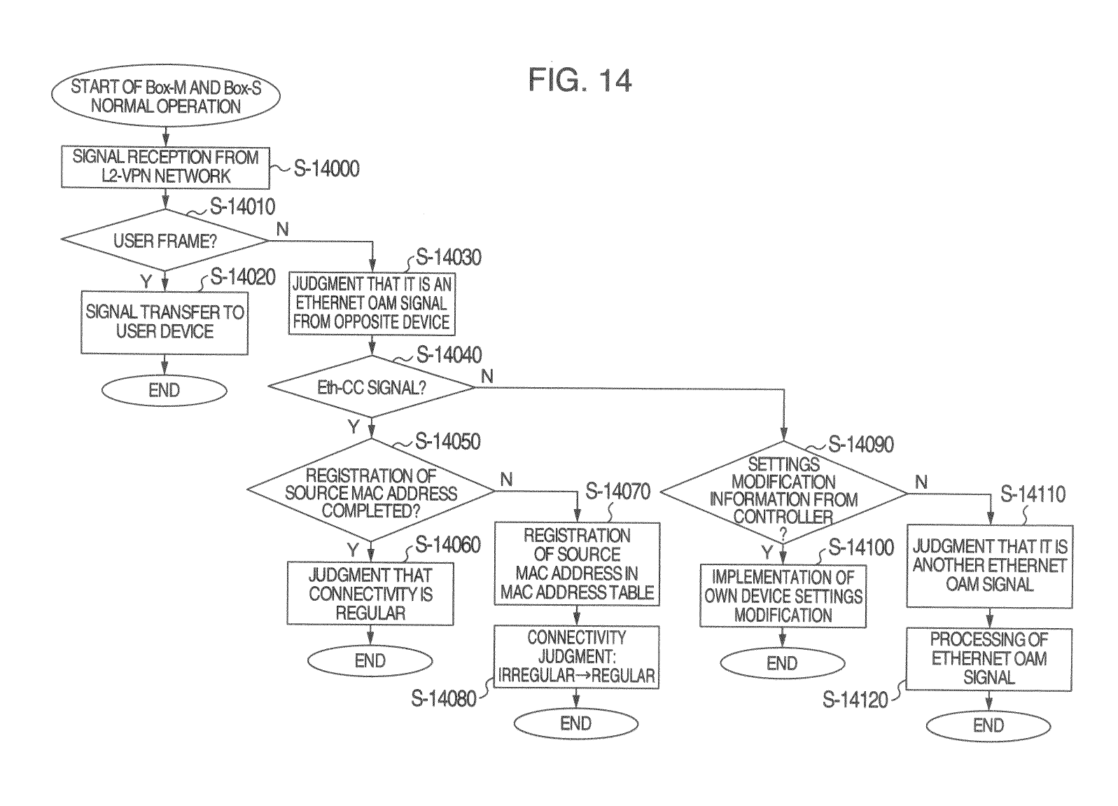

FIG. 14 is a sequence diagram pertaining to the reception process in the case where there has been received a signal from L2-VPN network 10 after the start of normal operation in terminating device Box-S 30 on the center side.

In the case where a signal has been transferred from L2-VPN 10, Box-M 40 and Box-S 30 store the same signal in frame buffer units 6090 and 7090 of Ethernet OAM separation and termination units 6020 and 7020 (Step 14000). Subsequently, Ethernet OAM separation and termination units 6020 and 7020 judge whether the concerned signal is a user frame or an Ethernet OAM signal (Step 14010).

In case it was judged that the concerned signal is a user frame, Ethernet OAM separation and termination units 6020 and 7020 transfer the concerned signal to the L2-VPN network (Step 14020). Moreover, Ethernet OAM separation and termination units 6020 and 7020, in the case of judging the concerned signal to be an Ethernet OAM signal, make the concerned signal be transferred to Ethernet OAM processing units 6060 and 7060 and continue necessary processing (Step 14030). Ethernet OAM processing units 6060 and 7060 analyze the transferred signal and judge whether the concerned signal is an Eth-CC signal or another Ethernet OAM signal (Step 14040).

In the case where Ethernet OAM processing units 6060 and 7060 judge the concerned signal to be an Eth-CC signal, information thereabout is reported to connectivity monitoring units 6110 and 7110. Connectivity monitoring units 6110 and 7110 refer to source MAC address 3010 of the Eth-CC signal included in the reported information and MAC address 1202 of connection destination DB 6055 or MAC address 1302 of controller/master DB 7055 and judges the regularity of the connectivity with the concerned device of source MAC address 3010 (Steps 14050 and 14060).

Also, in the case, e.g., where a Box-S 30 is newly installed in network 1, the source MAC address of the Eth-CC signal transmitted from the newly installed Box-S 30 is not registered in connection destination DB 6055 of Box-M 40. However, since settings information such as the unit ID of the newly installed Box-S 30 is e.g. transferred or the like from controller 50 and registered in Box-M 40, it is possible for Box-M 40 to judge from the unit ID of the concerned Eth-CC signal that the concerned signal is an Eth-CC signal from the newly installed Box-S 30.

Accordingly, Box-M 40 newly registers source MAC address 3010 of the Eth-CC signal from the newly installed Box-S 30 in the entry of MAC address 1202 corresponding to the concerned unit ID 1201 of connection destination DB 6055 and changes the judgment on the connectivity with the concerned Box-S 30 from “Anomaly” to “Regular” (Steps 14050, 14070, and 14080). Further, as for the functioning on the side of the concerned Box-S 30, it is omitted since it is the same as that described in FIG. 10 and FIGS. 13A and 13B.

In the case where Ethernet OAM processing units 6060 and 7060 judge the concerned signal to be an Ethernet OAM signal other than an Eth-CC signal, the same judge whether the concerned signal is settings modification information from controller 50 or another Ethernet OAM signal (Step 14090). Ethernet OAM processing units 6060 and 7060, in the case of judging the concerned signal to be settings modification information from controller 50, transfer the settings modification information to settings administration units 6080 and 7080. Settings administration units 6080 and 7080 store the transferred information and bring out the settings modification to their own devices (Step 14100). Moreover, Ethernet OAM administration units 6060 and 7060, in the case of judging that the concerned signal is an Eth-CC signal or an Ethernet OAM signal other than a settings modification signal from the controller, implement processing that is necessary inside their own blocks (Steps 14090, 14110, and 14120).

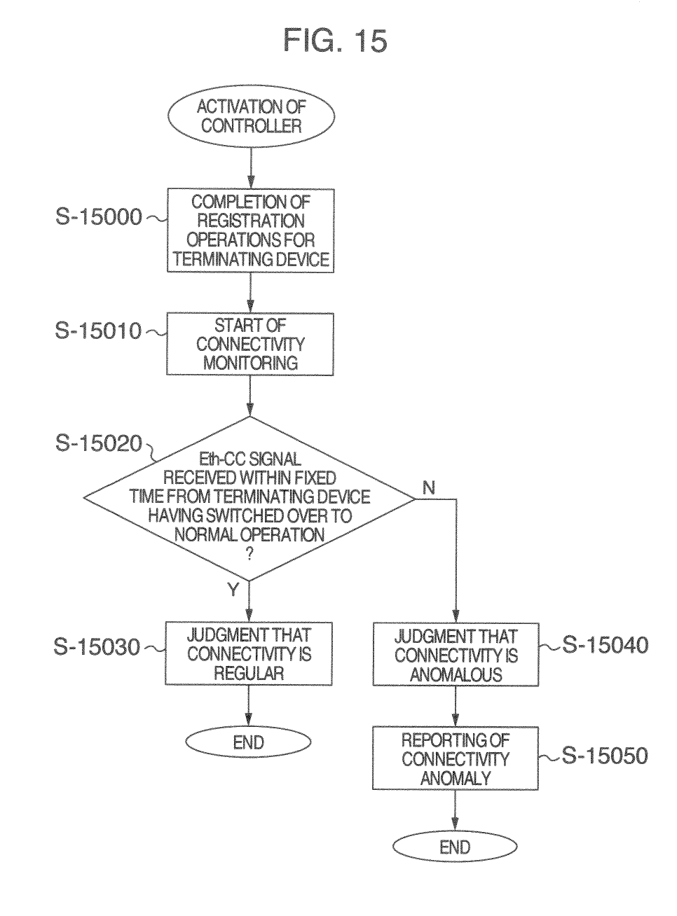

FIG. 15 is an example of a sequence, carried out by controller 50, implementing a judgment of the connectivity between Box-M 40 and Box-S 30. The check of the connectivity using Eth-CC signals occurring between controller 50 and Box-M 40 or Box-S 30 is mainly one for checking the regularity of the path followed by a control signal between controller 50 and Box-S 30 or Box-M 40.

If the settings to Box-M 40 or Box-S 30 for a switchover to normal operation are completed (Step 8100 in FIG. 8 and Step 9100 in FIG. 9), controller 50 starts the monitoring of the connectivity with the concerned device (Steps 15000 and 15010).

Regarding the connectivity monitoring, the Eth-CC signal received from the concerned device described so far is utilized. In other words, controller 50 transmits an Eth-CC signal in which there is set a multicast MAC address determined in advance in destination MAC address 3000 and as for the Box-M 40 or Box-S 30 able to receive this Eth-CC signal, it is confirmed that the connection with controller 50 is regular. Also, controller 50, by receiving an Eth-CC signal from Box-M 40 or Box-S 30, confirms the connectivity with these terminating devices, and destination MAC address 3000 of this Eth-CC signal is the MAC address of controller 50, this being a unicast address.

It is possible for controller 50 to distinguish a terminating device that has switched over to normal operation, i.e. a terminating device for which a MAC address is registered in registration information DB 5055. Accordingly, controller 50, if receiving an Eth-CC signal within a fixed time from a Box-M 40 or a Box-S 30 having switched over to normal operation, judges that the connectivity with the concerned device is regular (Steps 15020 and 15030).

Moreover, controller 50, in the case of being unable to received the aforementioned Eth-CC signal within a fixed time, judges that there has occurred an anomaly in the connectivity with the concerned device and reports a connectivity anomaly to the operator or a required report recipient (Steps 15040 and 15050).

Also, it is of course not possible for controller 50 to receive an Eth-CC signal from a Box-M 40 or Box-S 30 that has not switched over to normal operation. Accordingly, by using the aforementioned sequence, controller 50 is capable of processing to the effect of not judging the connectivity with the concerned device to have an anomaly until the installation work for the concerned device by the communication operator or the subscriber has been completed.

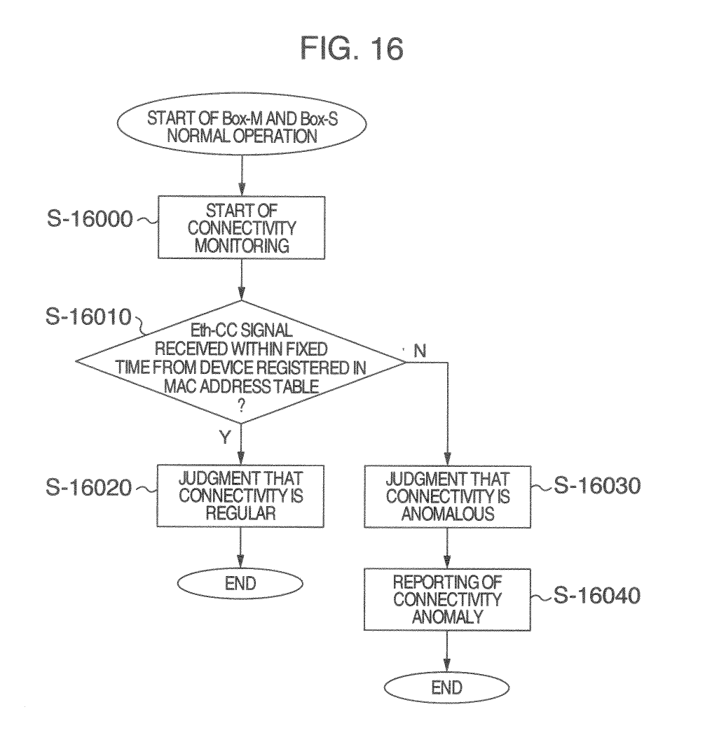

FIG. 16 is an example of a sequence in which a terminating device like Box-M 40 or Box-S 30 implements a connectivity judgment. The check of the connectivity with controller 50, as described above, takes as a main objective to judge the regularity of the relay path of the control signal, and a reciprocal check based on exchanging Eth-CC signals between Box-M 40 and Box-S 30 is mainly one for the purpose of checking the regularity of the path followed by user data and signals. Connectivity monitoring due to Box-M 40 or Box-S 30 is one whose communication is implemented by these devices themselves and takes as an objective to check the regularity of the path followed by the relay path of the control segment and the user data and signals.

After normal operation (Step 8110 in FIG. 8 and Step 9110 in FIG. 9), Box-M 40 or Box-S 30 starts monitoring of the connectivity with controller 50 or another terminating device (Step 16000). Regarding the connectivity monitoring, there is, similarly to the controller, utilized an Eth-CC signal received by the concerned device. At this point, as for Box-M 40 or Box-S 30, the connectivity information registered in connection destination DB 6055 and controller/master DB 7065 is set as the object of the monitoring. Accordingly, Box-M 40 or Box-S 30, since being unable to distinguish whether the opposite device has switched over to normal operation, wait for the arrival, regarding all the connection destinations registered in connection destination DB 6055 and controller/master DB 7065, of the concerned Eth-CC signals within a fixed time. Box-M 40 or Box-S 30, if receiving the concerned Eth-CC signal within the fixed time, judge that the connectivity with the concerned device is regular (Steps 16010 and 16020).

Moreover, Box-M 40 or Box-S 30, in the case of being unable to receive an Eth-CC signal from the concerned device within the fixed time period, judges that there has occurred an anomaly in the connectivity with the concerned device and reports a connectivity anomaly to the operator or a required report recipient (Steps 16030 and 16040). At this point, in case there exists a terminating device for which a MAC address is not yet registered inside connection destination DB 6055 or controller/master DB 7065, Box-M 40 or Box-S 30 judges that the connectivity with the concerned device is anomalous.

In the aforementioned sequence, since it is possible for controller 50 to distinguish whether each of the terminating devices has switched over to normal operation, it is also possible, regarding a report from a terminating device on the opposite side that has progressively declared anomalies in the connectivity with terminating devices that have not switched over to normal operation, to make a report to that effect at the same time to the operator.

Also, in the case where Box-M 40 or Box-S 30 has judged there to be an anomaly in the connectivity in the relay path of a control segment to and from controller 50, by reporting, via an opposite terminating device, a signal making a report to that effect, it is also possible for Box-M 40 or Box-S 30 to make a report to controller 50, without using the relay path of the control segment between the device itself where the failure has occurred and controller 50.

As mentioned above, there is constructed, in the present embodiment, a network configuration in which the terminating devices are divided into two types, Box-M 40 being a master and Box-S 30 being a slave. That is to say that, regarding terminating devices arranged in a plurality of base points, a network configuration is chosen in which a plurality of Box-S 30 are drawn together to a Box-M 40 installed in the front of a relay network. According to the aforementioned network configuration, the connectivity monitoring segment lies between slave terminating devices on the aggregated side (lower-level terminating devices) and a master terminating device (higher-level terminating device) on the aggregating side, to simplify the designation of the failure detection segment.

Also, since a high-level terminating device assembles a plurality of terminating devices under its command, a CCM frame utilizing a multicast MAC address is transmitted from the high-level terminating device. Moreover, the lower-level terminating devices transmit, to the higher-level terminating device, a CCM frame in which the MAC address of the higher-level terminating device, i.e. a unicast MAC address, is set for the destination MAC address. In this way, in the CCM frame transmitted from the higher-level terminating device and the CCM frame transmitted from the lower-level terminating device, it is possible, by using different destination MAC addresses, a multicast MAC address and a unicast MAC address, for different purposes, to diminish the load of connectivity monitoring on the network.

The aforementioned connectivity monitoring method was also applied to a control device (controller) of a communications operator controlling, in a consolidated way, a higher-level terminating device and lower-level terminating devices. That is to say that connectivity monitoring is implemented from the control device utilizing a multicast MAC address for the destination MAC address in the CCM frames to the higher-level terminating device or the lower-level terminating devices as well. Moreover, the higher-level terminating device or the lower-level terminating device transmits, to the control device, a CCM frame in which the destination MAC address is set to be a MAC address of the control device that is a unicast MAC address. In the CCM frame transmitted from the control device and the CCM frame transmitted from the higher-level terminating device or the lower-level terminating device, it is possible, by using different destination MAC addresses, a multicast MAC address and a unicast MAC address, for different purposes, to diminish the load of connectivity monitoring on the network.

A control device, a higher-level terminating device, and lower-level terminating devices that constitute a network check the MAC address of the device on the opposite side by respectively receiving CCM frames. The connectivity monitoring of the control device, the higher-level terminating device, and the lower-level terminating devices is implemented by means of the transmission and reception of CCM frames.

As described above, by the configuration and functioning of controller 50, Box-M 40, and Box-S 30 of the present embodiment, it becomes possible, while utilizing an existing L2-VPN network, to readily provide new connectivity monitoring between user base points. Also, in the connectivity monitoring between user base points, connectivity monitoring between a plurality of base points can be implemented simultaneously, making possible the bandwidth minimization of the monitoring frames, by using a dependency relationship like that of a master station and a slave station among the termination points. According to the present invention, the designation of a failed communication line or a failed segment becomes possible in the communication between user base points going through a plurality of regional networks.

Further, in the present embodiment, a description was carried out regarding the case of OAM signals, but this is only an example. If what is concerned is a maintenance monitoring system capable of transmitting signals such as frames or packets for monitoring the connectivity between devices to a plurality of devices, using a multicast address, it is possible to implement the present invention similarly to the aforementioned embodiment. Also, the Eth-CC signals are ones that check the connectivity between the receiving device and the transmitting device and it is of no concern to the device having transmitted the Eth-CC signal whether or not the correspondent device received the Eth-CC signal in a regular way. The device on the transmission side makes a reciprocal check with the correspondent device by receiving an Eth-CC signal that on the contrary is a reception side signal separately coming progressively by transmission. However, it is possible to similarly apply this invention even with respect to a signal for OAM that is devised to check connectivity like this Eth-CC signal, apart from a signal that does not in any way wait for a reply, after the transmission side has transmitted a signal, by obtaining the reply from the reception side that corresponds to the signal transmitted by the transmission side.

1. A terminating device terminating an OAM signal for Ethernet,
storing identity information for identifying uniquely a plurality of other terminating devices affiliated with a VLAN identified by the same VLAN ID;
transmitting a CCM frame using a multicast MAC address to said plurality of other terminating devices;
examining, when receiving a CCM frame in which the MAC address of the device itself is taken to be the destination MAC address respectively from said plurality of other terminating devices, whether said identity information, included in said CCM frame of said plurality of other terminating devices having received said CCM frame, is included in said stored identity information; and
associating, in the case where the identity information included in said CCM frame is included in said stored identity information, the source MAC address of said CCM frame with said identity information and storing the same.

2. The terminating device according to claim 1,
examining, if receiving from said other terminating devices having transmitted said CCM frame the CCM frame once again, whether the source MAC address included in said CCM frame is stored or not; and
judging, in the case where said source MAC address is stored, that the connectivity with said other terminating devices is regular.

3. A terminating device terminating an OAM signal for Ethernet,
storing identity information for identifying uniquely another terminating device affiliated with a VLAN identified by the same VLAN ID;
examining, if receiving a CCM frame in which a multicast MAC address is taken to be the destination MAC address from said other terminating device, whether said identity information included in said CCM frame is included in said stored identity information; and
associating, in the case where the identity information included in said CCM frame is included in said stored identity information, the source MAC address of said CCM frame with said identity information and storing the same.

4. The terminating device according to claim 3,
transmitting a CCM frame in which the MAC address of said other terminating device, associated with said identity information and stored, is taken to be the destination MAC address.

5. The terminating device according to claim 3,
examining, if receiving once again a CCM frame in which said multicast MAC address from said other terminating device is taken to be the destination, whether the source MAC address included in said CCM frame is stored or not; and
judging, in the case where said source MAC address is stored, that the connectivity with said other terminating device is regular.

6. A control device monitoring the connection between a plurality of terminating devices terminating an OAM signal for Ethernet,
affiliated with a VLAN identified by a VLAN ID that is the same as for said plurality of terminating devices;
storing a plurality of first identity information items for respectively identifying uniquely said plurality of terminating devices and a plurality of second information items for identifying uniquely said plurality of terminating devices inside a VLAN; and
reporting, to a first terminating device among said plurality of terminating devices, said second identity information items about a plurality of other, second terminating devices that should transmit CCM frames using a multicast MAC address of said first terminating device.

7. The control device according to claim 6,
reporting said second identity information item of said first terminating device to said second terminating devices.

8. The control device according to claim 6,
transmitting a CCM frame using a multicast MAC address to said plurality of terminating devices;
examining, if receiving a CCM frame in which the MAC address of the device itself is taken to be the destination MAC address from one terminating device among said plurality of terminating devices, whether said first identity information item, included in said CCM frame, of said first terminating device having transmitted said CCM frame is stored or not; and
associating, in the case where said first identity information item of said one terminating device is stored, the source MAC address of said CCM frame with said first identity information item of said one terminating device and storing the same.
